(19) United States
(12) Patent Application Publication
(10) Pub. No.: US 2012/0015675 A1
(43) Pub. Date: Jan. 19, 2012

(54) NETWORK SYSTEM, COMMUNICATION TERMINAL, COMMUNICATION METHOD, AND COMMUNICATION PROGRAM

(76) Inventors: Junji Suetsugu, Osaka (JP); Masayuki Kumagai, Osaka (JP); Toshio Akabane, Osaka (JP); Tatsuya Sakai, Osaka (JP)

(21) Appl. No.: 13/259,055

(22) PCT Filed: May 18, 2010
(86) PCT No.: PCT/JP2010/058373

§ 371 Date: Sep. 22, 2011

(30) Foreign Application Priority Data
May 19, 2009 (JP) 2009-121167

(51) Int. Cl. H04W 64/00

(52) U.S. Cl. 455/457

(57) ABSTRACT

A communication terminal includes: a communication unit; a memory; a first obtaining unit for obtaining first data; and a first control unit for detecting, using the communication unit, whether the communication terminal is in a first state in which the communication terminal can exchange the first data with another terminal or in a second state in which the communication terminal cannot exchange the first data with another terminal, thereby storing a part of the first data obtained during the second state in the memory as second data, and for transmitting the second data to another terminal when a transition from the second state to the first state occurs.

### TECHNICAL FIELD

The present invention relates to a network system including a plurality of communication terminals connectable to one another through a network, a communication terminal, a communication method, and a communication program. Particularly, the present invention relates to a network system including a plurality of communication terminals that exchange data with one another in real time, a communication terminal, a communication method, and a communication program.

### BACKGROUND ART

A chat system in which respective communication terminals transmit and receive data mutually has been known conventionally. In the chat system, the respective communication terminals exchange character information, current location information and the like in real time over the Internet and the like. Using the chat system, users of the respective communication terminals can have a conversation by means of characters or identify one another's current locations.

For example, Japanese Patent Laying-Open No. 8-5394 (Patent Literature 1) discloses a portable terminal device. According to Japanese Patent Laying-Open No. 8-5394 (Patent Literature 1), the portable terminal device calculates a current location from radio waves from a GPS satellite and transmits the current location to another portable terminal device. The portable terminal device displays the location information transmitted from the portable terminal device on a map in an overlapping manner. Therefore, each portable terminal device includes map data storage means for storing map data, map display means for displaying the map data managed by the map data storage means, location detecting means for detecting a current location, transmitting means for transmitting the location detected by the location detecting means to another portable terminal device, receiving means for receiving the location transmitted from another portable terminal device, and location display means for displaying a mark at the location received by the receiving means on the map data displayed by the map display means.

In addition, Japanese Patent No. 3965202 (Patent Literature 2) discloses network communication equipment that allows a predefined packet group necessary for maintaining a ring to be shared by the entire ring. According to Japanese Patent No. 3965202 (Patent Literature 2), a plurality of nodes are configured in the shape of a ring, and by transferring, within the ring, a message transmitted from an arbitrary node serving as a starting point, the message is multicasted within the ring. When the message does not reach a destination node, a message that this node has entered a disconnected state is generated and transmitted in the forward and reverse directions within the ring except for this destination.

In addition, Japanese Patent Laying-Open No. 2005-266986 (Patent Literature 3) discloses a mobile communication system. According to Japanese Patent Laying-Open No. 2005-266986 (Patent Literature 3), mobile phones make group settings for chat mails, and when a chat mail is transmitted and received between them via a mail server, the transmitted and received chat mail data is stored in a memory of each mobile phone terminal and displayed. When a different mobile phone participates in the group of the chat mails between the mobile phones in the middle of the chat mails, the different mobile phone first makes group settings for chat mails. The mobile phone transfers the chat mail data accumulated in the memory to the different mobile phone to cause the different mobile phone to display the previous chat mail data. The different mobile phone stores this data in a memory and displays this data.

### CITATION LIST

### Patent Literature

### PTL 1: Japanese Patent Laying-Open No. 8-539

### PTL 2: Japanese Patent No. 3965202

### PTL 3: Japanese Patent Laying-Open No. 2005-266986

### SUMMARY OF INVENTION

### Technical Problem

The system (that will be referred to as “location exchange system” hereinafter) in which by constantly transmitting and receiving one another's current location information among terminals that belong to a group, each terminal displays a mark indicating the current location on the map, as disclosed in Japanese Patent Laying-Open No. 8-5394 (Patent Literature 1) and the like, has the following properties. In other words, when the communication sensitivity becomes bad or when higher priority is given to an incoming call and communication (transmission and reception of the current location information) is temporarily interrupted, group terminals of the system stop transmission of the current location information of a terminal to the group terminals or stop reception and display of the current location information transmitted from the group terminals, until a state in which communication is possible returns thereafter.

Therefore, a terminal (terminal A) that has withdrawn from the location exchange system and a user of the terminal cannot deal with changes in other terminals (such as terminal B and terminal C) during the withdrawal. For example, a user of terminal A cannot check the current state of the other terminals immediately. Even if the user of terminal A can check the current state of the other terminals, the user of terminal A may not understand why the other terminals have fallen into such a state.

The present invention has been made to solve the above problems and an object thereof is to provide a network system in which, when a communication terminal that has fallen into a state in which the communication terminal does not receive data for a certain time period returns to a network, information exchanged by other communication terminals during that time period can be effectively output without requiring a large-scale memory. The object of the present invention is also to provide a communication terminal, a communication method and a communication program.

### Solution to Problem

According to an aspect of the present invention, there is provided a network system including at least a first terminal and a second terminal. The first terminal includes: a first communication unit; a memory; a first obtaining unit for obtaining first data; and a first control unit for detecting, using the first communication unit, whether the first terminal is in a first state in which the first terminal can exchange the first data with the second terminal or in a second state in which the first terminal cannot exchange the first data with the second terminal, thereby storing a part of the first data obtained during the second state in the memory as second data, and for transmitting the second data to the second terminal when a transition from the second state to the first state occurs. The second terminal includes: a display; a second communication unit; a second control unit for sequentially receiving the first data from the first terminal using the second communication unit during the first state, and receiving the second data from the first terminal when the transition from the second state to the first state occurs;

and a display control unit for causing the display to sequentially display the first data and the second data.

Preferably, the second terminal further includes a second obtaining unit for obtaining location information of the second terminal. The first obtaining unit obtains location information of the first terminal as the first data. The display control unit causes the display to display locations of the first terminal and the second terminal based on the location information of the first terminal and the second terminal.

According to another aspect of the present invention, there is provided a communication terminal connectable to another terminal through a network. The communication terminal includes: a communication unit; a memory; a first obtaining unit for obtaining first data; and a control unit for detecting, using the communication unit, whether the communication terminal is in a first state in which the communication terminal can exchange the first data with another terminal or in a second state in which the communication terminal cannot exchange the first data with another terminal, thereby storing a part of the first data obtained during the second state in the memory as second data, and for transmitting the second data to another terminal when a transition from the second state to the first state occurs.

According to another aspect of the present invention, there is provided a communication terminal connectable to another terminal through a network. The communication terminal includes: a display; a communication unit; a communication control unit for sequentially receiving the first data from another terminal using the communication unit during a first state in which another terminal can exchange first data with the communication terminal, and receiving second data from another terminal when a transition from a second state in which another terminal cannot exchange the first data with the communication terminal to the first state occurs; and a display control unit for causing the display to display the first data and the second data.

According to another aspect of the present invention, there is provided a communication method in a network system including at least a first terminal and a second terminal. The communication method includes the steps of: obtaining, by the first terminal, first data; detecting, by the first terminal, whether the first terminal is in a first state in which the first terminal can exchange the first data with the second terminal or in a second state in which the first terminal cannot exchange the first data with the second terminal, thereby storing a part of the first data obtained during the second state in a memory as second data; sequentially transmitting, by the first terminal, the first data to the second terminal during the first state; sequentially receiving, by the second terminal, the first data from the first terminal during the first state; transmitting, by the first terminal, the second data to the second terminal when a transition from the second state to the first state occurs; receiving, by the second terminal, the second data from the first terminal when the transition from the second state to the first state occurs; and causing, by the second terminal, a display to sequentially display the first data and the second data.

According to another aspect of the present invention, there is provided a communication method for a communication terminal connectable to another terminal through a network, the communication terminal including a communication unit, a processor and a memory. The communication method includes the steps of: obtaining, by the processor, first data; detecting, by the processor, whether the communication terminal is in a first state in which the communication terminal can exchange the first data with another terminal or in a second state in which the communication terminal cannot exchange the first data with another terminal, using the communication unit, thereby storing a part of the first data obtained during the second state in the memory as second data; and transmitting, by the processor, the second data to another terminal using the communication unit when a transition from the second state to the first state occurs.

According to another aspect of the present invention, there is provided a communication method for a communication terminal connectable to another terminal through a network, the communication terminal including a communication unit, a processor and a display. The communication method includes the steps of: sequentially receiving, by the processor, first data from another terminal using the communication unit during a first state in which another terminal can exchange the first data with the communication terminal; receiving, by the processor, second data from another terminal using the communication unit when a transition from a second state in which another terminal cannot exchange the first data with the communication terminal to the first state occurs; and causing, by the processor, the display to sequentially display the first data and the second data.

According to another aspect of the present invention, there is provided a communication program for allowing communication of a communication terminal connectable to another terminal through a network, the communication terminal including a communication unit, a processor and a memory. The communication program causes the processor to perform the steps of: obtaining first data; detecting, using the communication unit, whether the communication terminal is in a first state in which the communication terminal can exchange the first data with another terminal or in a second state in which the communication terminal cannot exchange the first data with another terminal, thereby storing a part of the first data obtained during the second state in the memory as second data; and transmitting the second data to another terminal using the communication unit when a transition from the second state to the first state occurs.

According to another aspect of the present invention, there is provided a communication program for allowing communication of a communication terminal connectable to another terminal through a network, the communication terminal including a communication unit, a processor and a display. The communication program causes the processor to perform the steps of: sequentially receiving the first data from another terminal using the communication unit during a first state in which another terminal can exchange first data with the communication terminal; receiving second data from another terminal using the communication unit when a transition from a second state in which another terminal cannot exchange the first data with the communication terminal to the first state occurs; and causing the display to sequentially display the first data and the second data.

### Advantageous Effects of Invention

As described above, according to the present invention, there is provided a network system in which, when a communication terminal that has fallen into a state in which the communication terminal does not receive data for a certain time period returns to a network, information exchanged by other communication terminals during that time period can be effectively output without requiring a large-scale memory. There is also provided a communication terminal, a communication method and a communication program.

### BRIEF DESCRIPTION OF DRAWINGS

FIG. 1 is a schematic diagram showing one example of a network system according to the present embodiment.

FIG. 2 is a sequence diagram showing an overview of operation in the network system according to the present embodiment.

FIG. 3 is an image diagram showing a transition of a display screen of a withdrawal terminal in accordance with the overview of the operation according to the present embodiment.

FIG. 4 is an image diagram showing a transition of a display screen of a management terminal in accordance with the overview of the operation according to the present embodiment.

FIG. 5 is a block diagram showing a hardware configuration of a communication terminal according to the present embodiment.

FIG. 6 is an image diagram showing data stored in a memory.

FIG. 7 is a block diagram showing a functional configuration of the communication terminal according to the present embodiment.

FIG. 8 is an image diagram showing a state of the memory of each communication terminal at the start of chat communication according to the present embodiment.

FIG. 9 is an image diagram showing a data flow of current location information obtained by a terminal A in the network system according to the present embodiment.

FIG. 10 is an image diagram showing a data flow when a terminal B withdraws from the chat communication during the chat communication in the network system according to the present embodiment.

FIG. 11 is an image diagram showing a data flow during withdrawal of terminal B from the chat communication in the network system according to the present embodiment.

FIG. 12 is an image diagram showing a data flow when terminal B returns to the chat communication in the network system according to the present embodiment.

FIG. 13 is an image diagram showing a data flow when terminal A further withdraws during withdrawal of terminal B.

FIG. 14 is an image diagram showing a data flow when terminal A first returns to the chat communication.

FIG. 15 is an image diagram showing a data flow when terminal B first returns to the chat communication.

FIG. 16 is an image diagram showing a modification of the data flow of the current location information obtained by the terminal in the network system.

FIG. 17 is an image diagram showing transmission and reception data of the current location information in the network system according to the present modification.

FIG. 18 is a flowchart showing a procedure of data transmission processing performed in the communication terminal according to the present embodiment.

FIG. 19 is a flowchart showing a procedure of normal location exchange processing performed in the communication terminal according to the present embodiment.

FIG. 20 is a flowchart showing a procedure of path display processing performed in the communication terminal according to the present embodiment.

FIG. 21 is a flowchart showing a procedure of path transmission processing performed in the communication terminal according to the present embodiment.

FIG. 22 is a first flowchart showing a procedure of location exchange processing performed in the communication terminal according to the present embodiment.

FIG. 23 is a second flowchart showing the procedure of the location exchange processing performed in the communication terminal according to the present embodiment.

FIG. 24 is a first flowchart showing a procedure of temporary withdrawal processing performed in the communication terminal according to the present embodiment.

FIG. 25 is a second flowchart showing the procedure of the temporary withdrawal processing performed in the communication terminal according to the present embodiment.

FIG. 26 is a flowchart showing a procedure of return processing performed in the communication terminal according to the present embodiment.

### DESCRIPTION OF EMBODIMENTS

Embodiments of the present invention will be described hereinafter with reference to the drawings. In the following description, the same components are denoted by the same reference characters. Their names and functions are also the same. Therefore, detailed description on them will not be repeated.

In addition, in the following, a mobile phone and a satellite navigation system will be described as a typical example of “communication terminal.” The mobile phone and the satellite navigation system herein have a function for obtaining a current location of the communication terminal itself, typically such as the GPS function, for example, and a memory storing map data. The mobile phone and the satellite navigation system can cause a display unit to display the current location of the communication terminal itself and current locations of other communication terminals on a map.

In the following, when a description is given of a configuration or a function common to each of the mobile phone and the satellite navigation system, the mobile phone and the satellite navigation system will be collectively called “communication terminal.” “Communication terminal,” however, is also applicable to other mobile information communication equipment such as a PND (Personal Navigation Device) and a PDA (Personal Data Assistance).

<Overall Configuration of Network System 1>

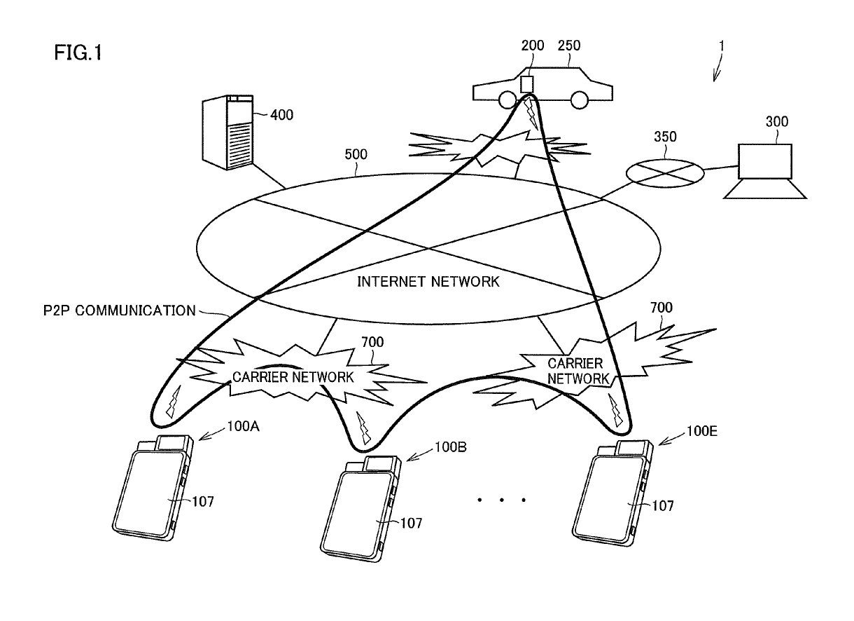

First, a description will be given of a first embodiment of a network system 1. FIG. 1 is a schematic diagram showing one example of network system 1 according to the present embodiment. As shown in FIG. 1, network system 1 includes a plurality of mobile phones 100A (100B, 100E), a matching server 400, an Internet network 500, and a carrier network 700. In addition, network system 1 according to the present embodiment includes a satellite navigation system 200 mounted on a vehicle 250, and a personal computer (PC; Personal Computer) 300.

Mobile phone 100A is configured to be connectable to carrier network 700. Satellite navigation system 200 is configured to be connectable to Internet network 500. Personal computer 300 is configured to be connectable to Internet network 500 through a LAN (Local Area Network) 350 or a WAN (Wide Area Network). Matching server 400 is configured to be connectable to Internet network 500.

More specifically, first to fifth mobile phones 100A, 100B and 100E (third and fourth mobile phones are not shown), satellite navigation system 200 and personal computer 300 can be connected to one another through carrier network 700, Internet network 500 and matching server 400, and can mutually transmit and receive data. In addition, first to fifth mobile phones 100A, 100B and 100E, satellite navigation system 200 and personal computer 300 have identification information for identifying themselves (such as a mail address and an IP (Internet Protocol) address, for example) allocated thereto. In other words, first to fifth mobile phones 100A, 100B and 100E, satellite navigation system 200 and personal computer 300 can store identification information of other communication terminals in an internal recording medium, and can transmit and receive data to/from the other communication terminals through carrier network 700, Internet network 500 and the like based on the identification information.

In the following, when a description is given of a configuration or a function common to each of first to fifth mobile phones 100A, 100B and 100E, and satellite navigation system 200, they will also be collectively called “communication terminal” in order to facilitate the description.

In this way, each communication terminal according to the present embodiment can transmit and receive data to/from the other communication terminals without matching server 400, using the IP address allocated to each communication terminal. Here, when each communication terminal accesses matching server 400, that is, when each communication terminal accesses the Internet, matching server 400, another not-shown server device or the like allocates the IP address to the communication terminal. Since details of IP address allocation processing is known, description thereof will not be repeated here.

In addition, each communication terminal according to the present embodiment can directly transmit and receive data mutually through the network, using the IP address allocated to each communication terminal. In other words, first to fifth mobile phones 100A, 100B and 100E, satellite navigation system 200 and personal computer 300 included in network system 1 according to the present embodiment can constitute a so-called P2P (Pear to Pear)-type network.

<Overview of Operation of Network System 1>

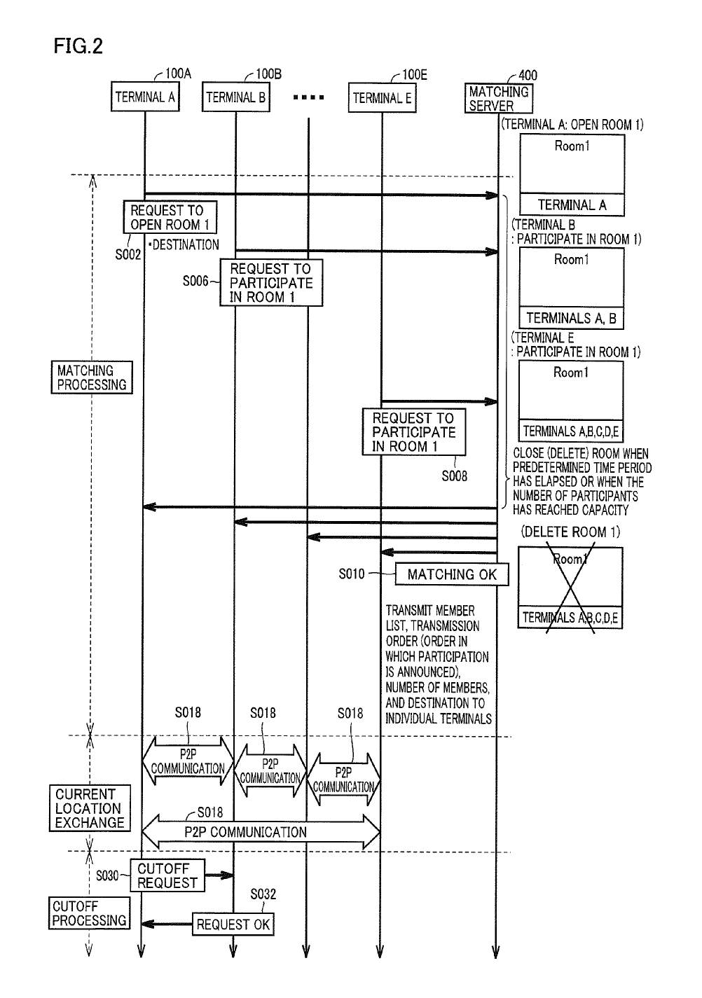

Next, a description will be given of an overview of operation of network system 1 according to the present embodiment. FIG. 2 is a sequence diagram showing the overview of the operation in network system 1. As shown in FIGS. 1 and 2, each communication terminal according to the present embodiment must exchange (obtain) each other's IP address first for P2P-type data transmission and reception. Each communication terminal obtains the IP address, and thereafter, transmits, to another communication terminal, message information, current location information, destination information and the like obtained by each communication terminal as a result of the P2P-type data transmission and reception.

As a result, each communication terminal can display a message input to each communication terminal, a message received from another communication terminal, and others in chronological order. Alternatively, each communication terminal can simultaneously display a current location of each communication terminal itself, a current location of another communication terminal, a destination and the like, and in some cases, can display a movement route that has been already followed by another communication terminal.

A case will, however, be described in the following where each communication terminal transmits and receives a message through a chat room created in matching server 400, and thereafter, P2P communication (also referred to as “chat communication” hereinafter) is carried out based on each other's IP address.

First, first mobile phone 100A (a terminal A in FIG. 2) requests IP registration (login) of matching server 400 (step S002). First mobile phone 100A may obtain its own IP address from matching server 400 simultaneously or may obtain its own IP address from another server device and the like in advance. More specifically, first mobile phone 100A transmits a mail address and an IP address of first mobile phone 100A to matching server 400 through carrier network 700 and Internet network 500, together with a message for requesting creation of a new chat room. First mobile phone 100A may transmit the capacity of participants in the chat room to matching server 400 together with the message.

Matching server 400 creates the chat room in response to the request. At this time, matching server 400 may notify first mobile phone 100A that the creation of the chat room has been completed. Matching server 400 stores the room name of the chat room and the IP addresses of the participating communication terminals in association with each other. In this way, first mobile phone 100 can create the new chat room and participate in this chat room.

A user of first mobile phone 100A informs a user of second mobile phone 100B (a terminal B in FIG. 2) that the new chat room has been created. In other words, the user of first mobile phone 100A invites the user of second mobile phone 100B to the chat room. For example, first mobile phone 100A transmits a mail for asking for participation in P2P, to second mobile phone 100B through carrier network 700 and Internet network 500. Alternatively, the user of first mobile phone 100A asks the user of the second mobile phone to participate in P2P by means of the telephone.

The user of second mobile phone 100B receives the mail or the telephone, and transmits a mail address and an IP address of second mobile phone 100B to matching server 400, together with a message that second mobile phone 100B will participate in the chat room having the designated room name (step S006). Second mobile phone 100B may obtain its own IP address from matching server 400 simultaneously or may obtain its own IP address first and access matching server 400. As a result, second mobile phone 100B can participate in the chat room.

Similarly, the user of first mobile phone 100A also informs users of the third and fourth mobile phones (not shown in FIG. 2) and fifth mobile phone 100E (a terminal E in FIG. 2) that the new chat room has been created. The user of fifth mobile phone 100E receives the mail or the telephone from first mobile phone 100A, and transmits a mail address and an IP address of fifth mobile phone 100E to matching server 400, together with a message that fifth mobile phone 100E will participate in the chat room having the designated room name (step S008). In this way, the third mobile phone to fifth mobile phone 100E can also participate in the chat room.

When a predetermined time period has elapsed since matching server 400 received the message for creation of the chat room or when the number of communication terminals participating in the chat room has reached the capacity of participants in the chat room, matching server 400 notifies first to fifth mobile phones 100A, 100B and 100E through Internet network 500 and carrier network 700 that matching has been completed.

More specifically, matching server 400 transmits the IP addresses of second to fifth mobile phones 100B and 100E to first mobile phone 100A. Matching server 400 transmits the IP addresses of first mobile phone 100A and the third mobile phone to fifth mobile phone 100E to second mobile phone 100B. Matching server 400 transmits the IP addresses of first to fourth mobile phones 100A and 100B to fifth mobile phone 100E. Then, matching server 400 deletes the chat room.

First mobile phone 100A, second mobile phone 100B and fifth mobile phone 100E authenticate one another based on the IP addresses of the other communication terminals. Then, first mobile phone 100A, second mobile phone 100B and fifth mobile phone 100E start chat communication with one another (step S018). Here, first mobile phone 100A, second mobile phone 100B and fifth mobile phone 100E mutually transmit and receive message information input to these mobile phones, current location information of these mobile phones themselves, destination information, route information and the like.

When first mobile phone 100A transmits a message for cutting off the chat communication to second mobile phone 100B (step S030), second mobile phone 100B transmits, to first mobile phone 100A, a message that second mobile phone 100B has accepted the cutoff request (step S032), and the chat communication between first mobile phone 100A and second mobile phone 100B ends.

<Overview of Operation of Withdrawal Terminal At The Time of P2P Communication>

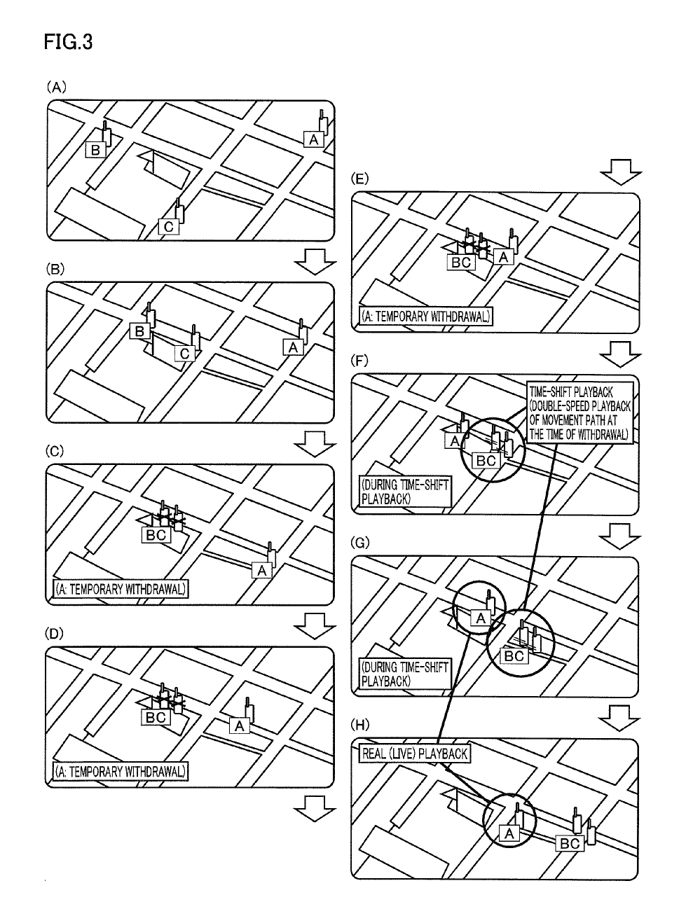

A description will be given hereinafter of an overview of first operation of a communication terminal at the time of the P2P communication (step S018 in FIG. 2) in network system 1 according to the present embodiment. FIG. 3 is an image diagram showing a transition of a display screen of a communication terminal (a withdrawal terminal A) according to the present embodiment.

Referring to FIGS. 3(A) and 3(B), a display 107 of the communication terminal according to the present embodiment displays a terminal's own current location and current locations of the other communication terminals on a map at the time of the P2P communication. As a result, a user of the communication terminal can know the terminal's own current location and the current locations of the other communication terminals. Specifically, terminal A displays the current location of terminal A itself (an icon such as “A” in FIG. 3) and the current locations of other terminals B and C (icons such as “B” and “C” in FIG. 3) on the map.

Assume that terminal A withdraws from the P2P communication. Referring to FIGS. 3(C) to 3(E), terminal A updates and displays only the current location of terminal A itself, in a state in which the current locations of terminals B and C cannot be obtained. In the present embodiment, terminal A accumulates a part (subset) of data obtained by terminal A itself during withdrawal. When terminal A returns to the chat communication, terminal A transmits the accumulated data to terminal B (or terminal C). It is to be noted that terminal B (or terminal C) also accumulates data transmitted and received by terminal B (or terminal C) itself during withdrawal of terminal A or a part (subset) of the data. When terminal A returns to the chat communication, terminal B (or terminal C) transmits the accumulated data to terminal A.

When terminal A returns to the P2P communication, terminal A obtains data indicating the locations of terminals B and C (data indicating the path) during withdrawal. As shown in FIGS. 3(F) and 3(G), terminal A shows a transition of the locations of terminals B and C during withdrawal while updating and displaying the current location of terminal A itself in real time. Terminal A according to the present embodiment displays changes in the locations of terminals B and C in fast forward.

Referring to FIG. 3(H), when terminal A finishes displaying the changes in the locations of terminals B and C during withdrawal in fast forward, terminal A updates and displays the locations of terminals A, B and C in real time.

In other words, in network system 1 according to the present embodiment, the order of priority of communication terminals that should manage respective communication terminals is determined in advance. When any one of the communication terminals (also referred to as “withdrawal terminal” hereinafter) withdraws, a communication terminal (also referred to as “management terminal” hereinafter) that should manage the withdrawal terminal accumulates data exchanged during withdrawal of the withdrawal terminal, for the withdrawal terminal.

In the present embodiment, when first mobile phone 100A withdraws from the chat communication, second mobile phone 100B accumulates a part (subset) of data received from the other communication terminals (such as third mobile phone 100C) and data transmitted to the other communication terminals (such as third mobile phone 100C) during withdrawal of first mobile phone 100A. When first mobile phone 100A returns to the chat communication, second mobile phone 100B transmits the accumulated data to first mobile phone 100A.

A communication terminal other than second mobile phone 100B may accumulate data during withdrawal of first mobile phone 100A. For example, when first mobile phone 100A withdraws from the chat communication, third mobile phone 100C may accumulate data received from the other communication terminals and data transmitted to the other communication terminals during withdrawal. When first mobile phone 100A returns to the chat communication, third mobile phone 100C may transmit the accumulated data to first mobile phone 100A.

With such a configuration, in network system 1 according to the present embodiment, when first mobile phone 100A returns to the chat communication, first mobile phone 100A can obtain the data exchanged with the other mobile phones during withdrawal. Only a communication terminal that should manage first mobile phone 100A may accumulate only the data exchanged during withdrawal. In other words, even if network system 1 is not equipped with a large-scale memory, first mobile phone 100A that has returned can obtain the data exchanged during withdrawal.

<Overview of Operation of Management Terminal At The Time of P2P Communication>

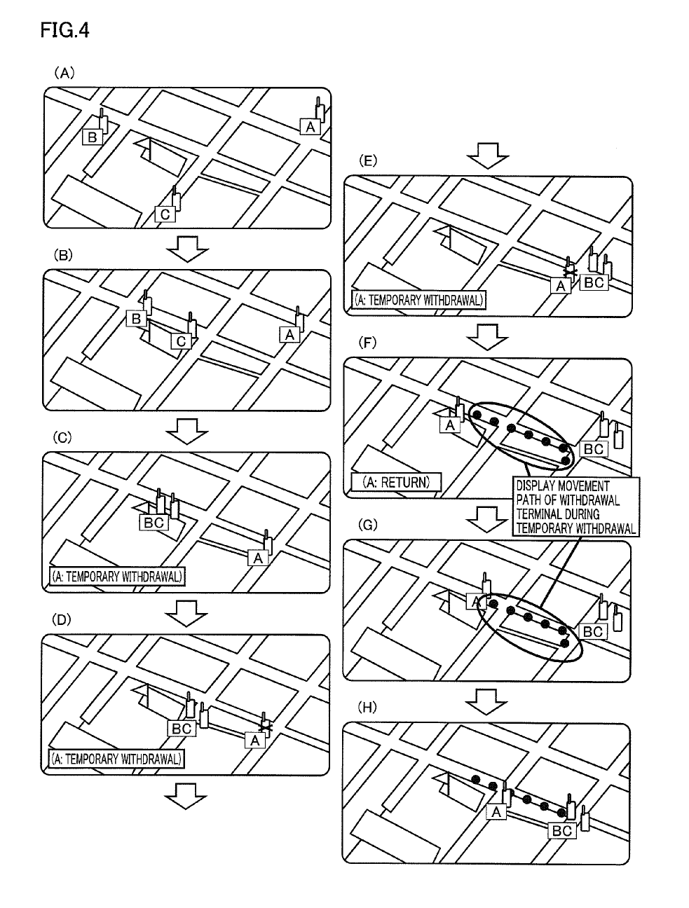

A description will be given hereinafter of an overview of second operation of the communication terminal at the time of the P2P communication (step S018 in FIG. 2) in network system 1 according to the present embodiment. FIG. 4 is an image diagram showing a transition of a display screen of a communication terminal (management terminal B, C) according to the present embodiment.

Referring to FIGS. 4(A) and 4(B), display 107 of the communication terminal according to the present embodiment displays a terminal's own current location and current locations of the other communication terminals on a map at the time of the P2P communication. As a result, a user of the communication terminal can know the terminal's own current location and the current locations of the other communication terminals. Specifically, terminal B displays the current location of terminal B itself (an icon such as “B” in FIG. 4) and the current locations of other terminals A and C (icons such as “A” and “C” in FIG. 4) on the map.

Assume that terminal A withdraws from the P2P communication. Referring to FIGS. 4(C) to 4(E), terminal B updates and displays only the current locations of terminals B and C, in a state in which the current location of terminal A cannot be obtained. As described above, terminal A accumulates a part (subset) of data obtained by terminal A itself during withdrawal. When terminal A returns to the chat communication, terminal A transmits the accumulated data to terminal B (or terminal C). It is to be noted that terminal B (or terminal C) also accumulates data transmitted and received by terminal B (or terminal C) itself during withdrawal of terminal A or a part (subset) of the data. When terminal A returns to the chat communication, terminal B (or terminal C) transmits the accumulated data to terminal A.

When terminal A returns to the P2P communication, terminal B obtains data indicating the location of terminal A (data indicating the path) during withdrawal. As shown in FIGS. 4(F) to 4(H), terminal B shows the path of the location of terminal A during withdrawal while updating and displaying the current locations of terminals A, B and C in real time. Terminal B according to the present embodiment displays a change in the location of terminal A as the movement route.

In other words, as described above, in the present embodiment, first mobile phone 100A accumulates data obtained by first mobile phone 100A itself during withdrawal or a part (subset) of the data. When first mobile phone 100A returns to the chat communication, first mobile phone 100A transmits the accumulated data to the other mobile phones.

With such a configuration, in network system 1 according to the present embodiment, when first mobile phone 100A returns to the chat communication, the other mobile phones can obtain the data obtained by first mobile phone 100A during withdrawal. First mobile phone 100A may only accumulate the data obtained by first mobile phone 100A itself during withdrawal. Therefore, even if network system 1 is not equipped with a large-scale memory, the other mobile phones can obtain the data obtained during withdrawal by first mobile phone 100A that has returned. For example, the users of the other mobile phones can know the movement route and the like of first mobile phone 100A during withdrawal.

A system is also possible in which exchanged location information of group terminals stored and managed in association with the location information exchange time is managed, and when a terminal that has withdrawn returns, the terminal displays a movement route of the group terminals from the time of withdrawal to the time of return. In such a system, however, an enormous amount of data should be stored and managed and an enormous amount of data should be communicated. For example, in a P2P system that does not have a management server, the load of the management terminal that accumulates data for the withdrawal terminal becomes enormous.

Such a problem can also be overcome in the network system according to the present embodiment. In other words, in network system 1 according to the present embodiment, when a communication terminal that has fallen into a state in which the communication terminal does not receive data for a certain time period returns to a network, information exchanged by other communication terminals during that time period can be effectively output without requiring a large-scale memory.

A configuration for implementing such a function will be described in detail hereinafter.

<Hardware Configuration of Mobile Phone 100>

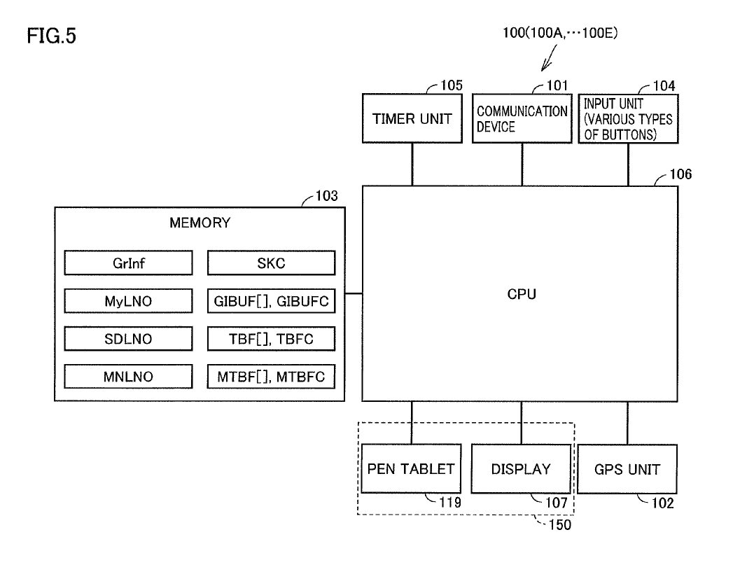

A description will be given of a hardware configuration of a mobile phone 100 according to the present embodiment. FIG. 5 is a block diagram showing a hardware configuration of the communication terminal according to the present embodiment.

As shown in FIG. 5, the communication terminal according to the present embodiment includes a communication device 101 that transmits and receives data to/from an external communication terminal through the network, a GPS unit 102 that obtains the terminal's own current location information, a memory 103 that stores a program and various types of databases, an input unit 104 that accepts an input of various types of information, a timer unit 105 that measures the time (time period), a CPU (Central Processing Unit) 106, display 107, and a pen tablet 119.

Communication device 101 converts communication data from CPU 106 to a communication signal and sends the communication signal via a not-shown antenna. Communication device 101 converts a communication signal received via the antenna to communication data and inputs the communication data to CPU 106.

GPS unit 102 produces current location information indicating the current location of the communication terminal, based on radio waves for positioning received from a satellite and the like via a not-shown positioning antenna, and inputs the current location information to CPU 106.

Input unit 104 accepts information from the user through key input operation and the like. For example, input unit 104 includes numerical keys, a decision key and the like, and accepts a command for selecting a destination address, an input of a body of a mail and the like.

CPU 106 controls each unit of mobile phone 100. CPU 106 reads a control program from memory 103 and executes the control program. CPU 106 accepts various types of commands from the user via input unit 104. CPU 106 transmits and receives data to/from the external communication terminal via communication device 101 and the network.

For example, CPU 106 transmits the current location information obtained by GPS unit 102 to another communication terminal or receives the current location information from another communication terminal via communication device 101. CPU 106 sequentially stores the current location information obtained by GPS unit 102 in memory 103 as route information or transmits the route information to another communication terminal via communication device 101.

Display 107 according to the present embodiment is formed of a liquid crystal panel or a CRT (Cathode Ray Tube). In the communication terminal according to the present embodiment, pen tablet 119 is placed on the lower side (rear side) of display 107. As a result, the user can input in handwriting graphic information and the like to CPU 106 via pen tablet 119, using, for example, a stylus pen, his/her finger and the like. In other words, display 107 and pen tablet 119 according to the present embodiment constitute a so-called touch panel.

Memory 103 is implemented by, for example, a volatile S-RAM (Static-Random Access Memory) serving as a work memory, a non-volatile ROM (Read Only Memory) that stores the control program and the like, a non-volatile NV-RAM (Non-Volatile Random Access Memory), a non-volatile HDD (Hard Disk Drive) that stores static image data, moving image data and the like, and other memories. Memory 103 stores the IP address of each communication terminal, the state of each communication terminal, the current location information of each communication terminal, a predefined packet group and the like.

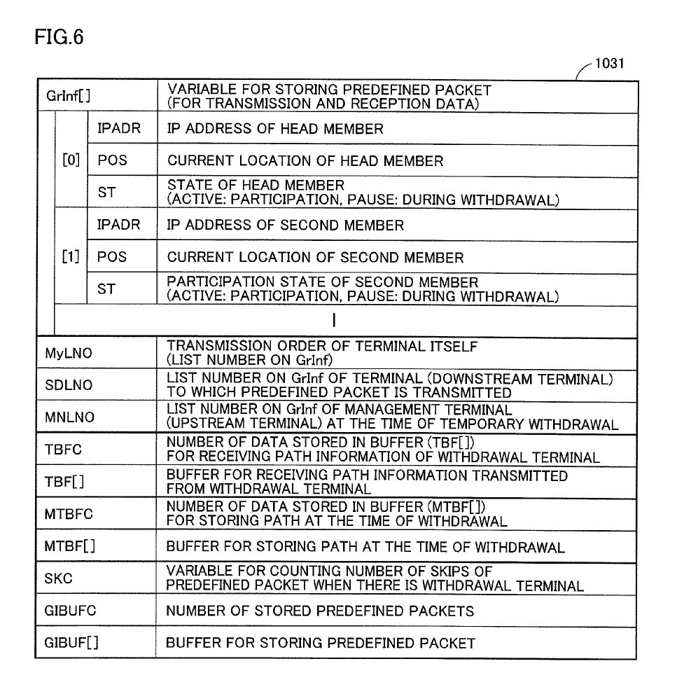

FIG. 6 is an image diagram showing the data stored in memory 103. Referring to FIG. 6, memory 103 stores a variable GrInf[] for storing the terminal's own current location and a predefined packet received from another communication terminal. Based on the terminal's own current location and the predefined packet, memory 103 stores an IP address IPADR, current location information POS, status information ST indicating whether or not the terminal participates in the P2P communication, for every terminal that belongs to the group carrying out the P2P communication, that is, for every number for identifying the terminal.

Memory 103 stores MyLNO that is a list number on GrInf indicating the transmission order of the terminal itself, SDLNO that is a list number on GrInf for identifying a terminal for transmitting the predefined packet (in the present embodiment, a terminal next to the terminal itself on the downstream side), and MNLNO that is a list number on GrInf for identifying a management terminal (in the present embodiment, a terminal next to the terminal itself on the upstream side) at the time of temporary withdrawal.

Memory 103 stores the number of data TBFC stored in a buffer (TBF[]) for receiving path information of the withdrawal terminal, and buffer TBF[] for receiving the path information group transmitted from the withdrawal terminal.

Memory 103 stores the number of data MTBFC stored in a buffer (MTBF[]) that stores a path at the time of withdrawal, and buffer MTBF[] for storing the path at the time of withdrawal.

Memory 103 stores a variable SKC for counting the number of skips of the predefined packet, the number of the stored predefined packets GIBUFC, and a predefined packet storage buffer GIBUF[].

It is to be noted that the predefined packet includes current location information of another communication terminal. Predefined packet storage buffer GIBUF[] includes current location information and message information transmitted and received by the chat communication after another communication terminal withdraws from the chat communication. In other words, predefined packet storage buffer GIBUF[] of memory 103 stores a batch of the predefined packets as a predefined packet group.

For example, when CPU 106 of fifth mobile phone 100E shown in FIGS. 1 and 2 receives a withdrawal notification from first mobile phone 100A via communication device 101, CPU 106 of fifth mobile phone 100E stores identification information for identifying first mobile phone 100A and status information indicating the withdrawal state of first mobile phone 100A in memory 103 in association with each other. Then, CPU 106 of fifth mobile phone 100E stores the current location information of another communication terminal received after reception of the withdrawal notification and the current location information of fifth mobile phone 100E itself obtained after reception of the withdrawal notification, in memory 103 as the predefined packet group in association with the identification information.

Thereafter, when CPU 106 of fifth mobile phone 100E receives a withdrawal notification from second mobile phone 100B via communication device 101, CPU 106 of fifth mobile phone 100E stores identification information for identifying second mobile phone 100B and status information indicating the state of second mobile phone 100B at the time of withdrawal in memory 103 in association with each other. Then, CPU 106 of fifth mobile phone 100E stores the current location information of another communication terminal received after reception of the withdrawal notification and the current location information of fifth mobile phone 100E itself obtained after reception of the withdrawal notification, in memory 103 as the predefined packet in association with the identification information.

When CPU 106 of fifth mobile phone 100E receives a return notification from first mobile phone 100A via communication device 101, CPU 106 of fifth mobile phone 100E reads, from memory 103, the status information, the current location information of another communication terminal and the current location information of fifth mobile phone 100E itself, based on the identification information for identifying first mobile phone 100A, and transmits these information to first mobile phone 100A via communication device 101.

In addition, when CPU 106 of fifth mobile phone 100E receives a return notification from second mobile phone 100B via communication device 101, CPU 106 of fifth mobile phone 100E reads, from memory 103, the status information, the current location information of another communication terminal and the current location information of fifth mobile phone 100E itself, based on the identification information for identifying second mobile phone 100B, and transmits these information to second mobile phone 100B via communication device 101. In other words, CPU 106 reads the predefined packet group for second mobile phone 100B from memory 103 and transmits the predefined packet group to second mobile phone 100B.

<Functional Configuration of Network System and Communication Terminal>

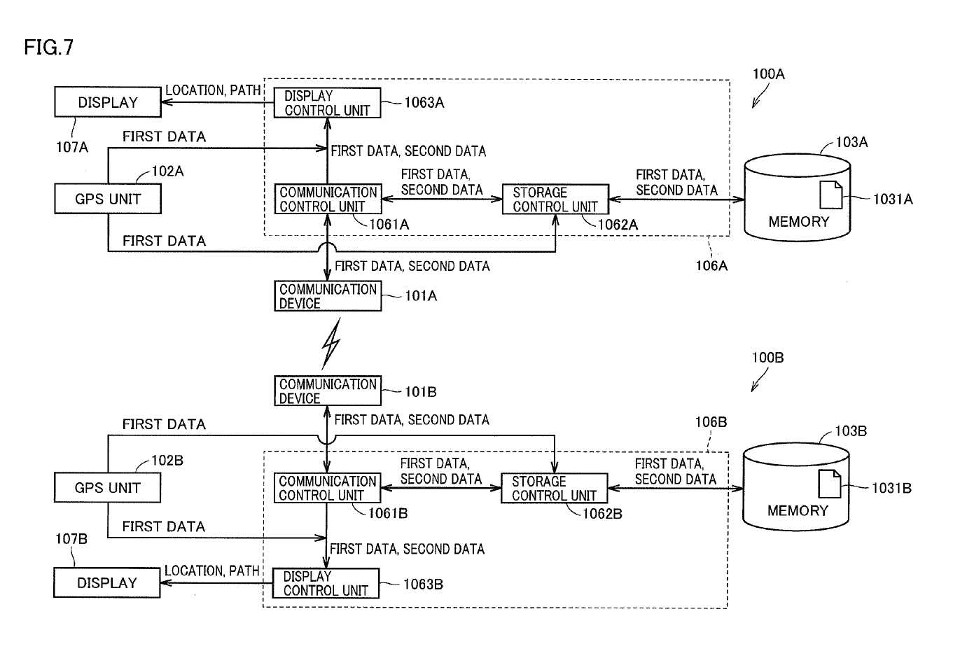

FIG. 7 is a block diagram showing a functional configuration of network system 1 and the communication terminal (first mobile phone 100A, second mobile phone 100B) according to the present embodiment. As shown in FIG. 7, first mobile phone 100A according to the present embodiment includes a communication device 101A, a communication control unit 1061A, a storage control unit 1062A, a display control unit 1063A, a display 107A, a GPS unit 102A, and a memory 103A.

Since a functional configuration of second mobile phone 100B connected to first mobile phone 100A through Internet network 500 is similar to that of first mobile phone 100A, description thereof will not be repeated here.

As already described, GPS unit 102A (location information obtaining unit) is implemented by a not-shown positioning antenna, a not-shown GPS signal processing unit or the like. In other words, GPS unit 102A receives radio waves for positioning from the GPS satellite and the like and obtains current location information (a location coordinate including longitude and latitude) of first mobile phone 100A. GPS unit 102A stores the obtained current location information in POS of memory 103A.

Input unit 104A accepts a message, a destination, a mail address of another communication terminal and the like from the user, and stores the message and the destination in memory 103A. It is to be noted that instead of input unit 104A, pen tablet 119 may accept a message, a destination, a mail address of another communication terminal and the like from the user, and store the message and the destination.

Display 107A displays an image and a text based on data from display control unit 1063A. Specifically, display 107A displays a message input to first mobile phone 100A and a message received from another communication terminal, based on the data from display control unit 1063A. In addition, display 107A displays, on a map, a current location of first mobile phone 100A itself, a current location of another communication terminal, a destination, and a movement route of another communication terminal.

Communication device 101A is implemented by a not-shown communication antenna or signal processing unit. Communication device 101A transmits various types of data to another communication terminal and receives various types of data from another communication terminal through Internet network 500 and carrier network 700.

<Functional Configuration of CPU 106A>

Communication control unit 1061A, storage control unit 1062A and display control unit 1063A are functions implemented by a CPU 106A and the like. More specifically, each function of CPU 106A is a function (module) implemented by CPU 106A executing the control program stored in memory 103A and the like and controlling each hardware shown in FIG. 5. For example, CPU 106A implements the above functional block by reading the program prestored in the ROM, the HDD and the like that implement the non-volatile memory of memory 103A, into the S-RAM that implements the work memory of memory 103A, and executing the program.

During the chat communication, communication control unit 1061A receives current location information (reception data) from another communication terminal through Internet network 500 using communication device 101A, and stores the current location information in POS of memory 103A or transfers the current location information to display control unit 1063A. Conversely, communication control unit 1061A transmits current location information received from another communication terminal and current location information (transmission data) obtained by GPS unit 102A to another communication terminal through Internet network 500 using communication device 101A.

During the chat communication, communication control unit 1061A transmits a message (transmission data) input to first mobile phone 100A to another communication terminal through Internet network 500 and the like using communication device 101A. Conversely, communication control unit 1061A receives a message (reception data) from another communication terminal through Internet network 500 using communication device 101A, and stores the message in memory 103A or transfers the message to display control unit 1063A.

At the end of the chat communication, communication control unit 1061A of the withdrawal terminal transmits a withdrawal notification to another communication terminal through Internet network 500 and the like using communication device 101A, based on a withdrawal command input via input unit 104. For example, the withdrawal notification includes location information stored in the communication terminal that will withdraw. In addition, in the case where a predefined packet group for another communication terminal is stored in memory 103A, communication control unit 1061A also transmits the predefined packet group to another communication terminal together with the withdrawal notification, when input unit 104A accepts the withdrawal command.

Communication control unit 1061A of the management terminal receives the withdrawal notification from another communication terminal using communication device 101A, and updates ST of memory 103 relating to this another communication terminal to the non-chatting state. In addition, communication control unit 1061A also receives the predefined packet group from another communication terminal together with the withdrawal command.

When communication control unit 1061A of the management terminal accepts the withdrawal notification from another communication terminal, memory 103A serving as the management terminal stores the status information in memory 103A in association with another communication terminal. More specifically, when communication control unit 1061A accepts the withdrawal notification from another communication terminal, storage control unit 1062A stores the current location information obtained thereafter by first mobile phone 100A via GPS unit 102A and communication device 101A in predefined packet storage buffer GIBUF[] of memory 103A, as the predefined packet group for this another communication terminal.

When communication control unit 1061A accepts the withdrawal notification from another communication terminal, storage control unit 1062A of the management terminal stores a part of the current location information (first data) obtained via GPS unit 102A and communication device 101A in predefined packet storage buffer GIBUF[] of memory 103, as a predefined packet group (second data).

When communication control unit 1061A of the management terminal accepts a return notification via communication device 101A, communication control unit 1061A transmits the predefined packet group stored in predefined packet storage buffer GIBUF[] of memory 103A to another communication terminal (withdrawal terminal).

When input unit 104A accepts the withdrawal command, storage control unit 1062A of the withdrawal terminal stores the terminal's own current location information obtained thereafter by GPS unit 102A in the path information receiving buffer (TBF[]) of memory 103A, as a path information group. Storage control unit 1062A according to the present embodiment stores a part of the terminal's own current location information in the path information receiving buffer (TBF[]) of memory 103A, as the path information group. For example, when input unit 104A accepts the withdrawal command, storage control unit 1062A stores one out of every ten terminal's own current location information obtained thereafter by GPS unit 102A in the path information receiving buffer (TBF[]) of memory 103A, as the path information group.

When input unit 104A accepts a return command, communication control unit 1061A of the withdrawal terminal transmits the path information group stored in the path information receiving buffer (TBF[]) of memory 103A to another communication terminal (management terminal).

When communication control unit 1061A of the management terminal accepts the predefined packet group from another communication terminal together with the withdrawal notification, communication control unit 1061A stores the current location information obtained thereafter by first mobile phone 100A via GPS unit 102A and communication device 101A in memory 103A, as the predefined packet group for this another communication terminal. In addition, communication control unit 1061A stores the current location information in memory 103A as an additional predefined packet group for another communication terminal corresponding to the received predefined packet group.

At the restart of the chat communication, communication control unit 1061A of the withdrawal terminal transmits the return notification to another communication terminal through Internet network 500 and the like using communication device 101A, based on the return command input via input unit 104. Communication control unit 1061A transmits the path information group to another communication terminal using communication device 101A together with the return notification, or transmits the path information group included in the return notification to another communication terminal using communication device 101A.

Communication control unit 1061A of the management terminal receives the return command from another communication terminal using communication device 101A, and updates ST relating to this another communication terminal to the chatting state. Communication control unit 1061A receives the path information group from another communication terminal using communication device 101A, and stores the path information group in memory 103A.

When communication control unit 1061A of the management terminal receives the return command from another communication terminal, communication control unit 1061A reads the predefined packet group corresponding to this another communication terminal from memory 103A. Communication control unit 1061A transmits the predefined packet group to this another communication terminal via communication device 101A. Communication control unit 1061A of the withdrawal terminal receives the predefined packet group from another communication terminal, and stores the predefined packet group in memory 103A.

Display control unit 1063A refers to POS of memory 103A and causes display 107A to display the terminal's own current location and the current location of another communication terminal. Furthermore, display control unit 1063A refers to memory 103A and causes display 107A to display the message input to the terminal itself and the message received from another communication terminal.

Display control unit 1063A of the withdrawal terminal refers to memory 103A and causes display 107A to display a movement route of each communication terminal based on the received predefined packet group. In the present embodiment, display control unit 1063A displays a moving image indicating movement of each communication terminal.

Display control unit 1063A of the management terminal refers to memory 103A and causes display 107A to display the movement route of the withdrawal terminal based on the received path information group. It is to be noted that in the present embodiment, display control unit 1063A displays a static image indicating movement of the withdrawal terminal.

Particularly, until the withdrawal command is accepted, display control unit 1063A of the withdrawal terminal according to the present embodiment causes display 107A to display the terminal's own current location and the current location of another communication terminal on the map, based on the current location information from GPS unit 102A and the predefined packet from another communication terminal. When the withdrawal command is accepted, display control unit 1063A causes display 107A to display a new current location by updating the terminal's own current location based on the current location information from GPS unit 102A.

When the return command is accepted, display control unit 1063A causes display 107A to display the terminal's own current location based on the current location information from GPS unit 102A, and causes display 107A to display a change in the current location of another communication terminal based on the predefined packet group from another communication terminal. Display control unit 1063A according to the present embodiment causes display 107A to display animation (moving image) indicating the change in the current location of another communication terminal over a predetermined time period (at tenfold speed), based on the predefined packet group.

Until communication control unit 1061A of the management terminal according to the present embodiment accepts the withdrawal notification, communication control unit 1061A transmits the current location information from GPS unit 102A and the predefined packet from another communication terminal to another communication terminal using communication device 101. As described above, when communication control unit 1061A receives the withdrawal notification, storage control unit 1062 stores the current location information from GPS unit 102A and a part of the predefined packet from another communication terminal in memory 103 as the predefined packet group for the withdrawal terminal.

When communication control unit 1061A accepts the return notification, communication control unit 1061A transmits the predefined packet group to the withdrawal terminal. Display control unit 1063A receives the path information group from the withdrawal terminal. Put another way, until the return notification is accepted, display control unit 1063A relating to the withdrawal terminal according to the present embodiment causes display 107A to display the terminal's own current location and the current location of another communication terminal on the map, based on the current location information from GPS unit 102A and the predefined packet from another communication terminal. When the return notification and the path information group are accepted, display control unit 1063A according to the present embodiment causes display 107A to display a path (static image) indicating the change in the current location of another communication terminal, based on the path information group.

As a result, the communication terminal can obtain messages and location information that are exchanged by the chat communication from when the communication terminal transmits the withdrawal notification to when the communication terminal transmits the return notification. In addition, the communication terminal can obtain messages and location information of the withdrawal terminal from when the communication terminal receives the withdrawal notification to when the communication terminal receives the return notification.

Since the functional configurations of second mobile phone 100B and third mobile phone 100C are similar to that of first mobile phone 100A as described above, description thereof will not be repeated here.

Since network system 1 and mobile phones 100A and 100B according to the present embodiment are configured as described above, the following functions are attained, for example. First, during the chat communication, when the user of second mobile phone 100B inputs the withdrawal command to an input unit 104B, a communication control unit 1061 B transmits the withdrawal notification to first mobile phone 100A through Internet network 500 using a communication device 101B.

Communication control unit 1061A of first mobile phone 100A receives the withdrawal notification via communication device 101A, and updates ST relating to second mobile phone 100B. Second mobile phone 100B interrupts the chat communication via communication control unit 1061B and communication device 101B.

First mobile phone 100A sequentially accumulates the current location information of first mobile phone 100A itself obtained by GPS unit 102A and the current location information of another communication terminal received via communication device 101 in GIBUF[] as the predefined packet group for second mobile phone 100B. On the other hand, second mobile phone 100B accumulates a part of the current location information of second mobile phone 100B itself obtained by GPS unit 102A in memory 103A as the path information group.

When the user of second mobile phone 100B inputs the return command to input unit 104B, second mobile phone 100B restarts the chat communication based on the IP address of another communication terminal. Communication control unit 1061B transmits the return notification and the path information group to first mobile phone 100A through Internet network 500 using communication device 101B.

Communication control unit 1061A receives the return notification via communication device 101A, and updates ST relating to second mobile phone 100B. Display control unit 1063A displays the movement path of second mobile phone 100B based on the path information group.

At this time, communication control unit 1061A of first mobile phone 100A transmits the predefined packet group to second mobile phone 100B through Internet network 500 using communication device 101A. A display control unit 1063B of second mobile phone 100B causes a display 107B to display the movement route of first mobile phone 100A, messages exchanged between first mobile phone 100A and the third mobile phone, and the like, based on the predefined packet group.

<Overview of Data Communication in Network System>

Next, a description will be given of an overview of data communication in network system 1 according to the present embodiment.

(State of Memory at Start of Chat Communication)

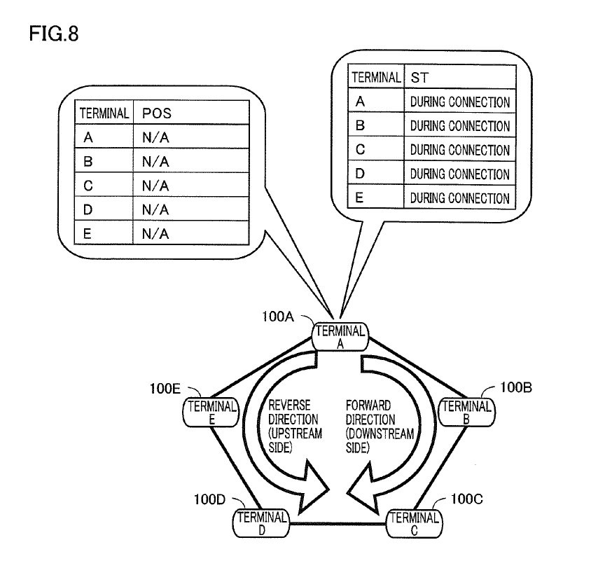

First, a description will be given of the state of memory 103 of each communication terminal at the start of the chat communication. FIG. 8 is an image diagram showing the state of memory 103 of each communication terminal at the start of the chat communication according to the present embodiment. The case will be described hereinafter where first mobile phone 100A (also referred to as “terminal A” hereinafter), second mobile phone 100B (also referred to as “terminal B” hereinafter), third mobile phone 100C (also referred to as “terminal C” hereinafter), fourth mobile phone 100D (also referred to as “terminal D” hereinafter), and fifth mobile phone 100E (also referred to as “terminal E” hereinafter) carry out the chat communication.

Referring to FIG. 8, in network system 1 according to the present embodiment, the current location information and message obtained by each communication terminal are conveyed from terminal A through terminal B, terminal C and terminal D to terminal E in this order. The current location information and message obtained by each communication terminal may, however, be conveyed from terminal E through terminal D, terminal C and terminal B to terminal A in this order.

In addition, communication terminals that participate in the chat communication are set as terminal A to terminal E in the order in which the communication terminals enter the room created in matching server 400. In other words, in the present embodiment, the current location information and the message are transmitted in the forward direction in FIG. 8. The communication terminals that participate in the chat communication may, however, be set as terminal A to terminal E in ascending order of the IP address, for example.

In addition, in network system 1 according to the present embodiment, a terminal (communication terminal) for managing each communication terminal (second communication terminal) is set as a terminal on the upstream side of the each communication terminal (second communication terminal). In other words, a terminal on the upstream side stores the predefined packet group for a terminal on the downstream side. The terminal (communication terminal) for managing each communication terminal (second communication terminal) may, however, be set as a terminal on the downstream side of the each communication terminal (second communication terminal). In other words, the order of priority of the terminal (communication terminal) for managing each communication terminal (second communication terminal) may only be preset.

Alternatively, network system 1 according to the present embodiment may be configured such that each communication terminal (second communication terminal) selects a communication terminal that manages itself from among other communication terminals at the time of withdrawal. In this case, when each communication terminal accepts the withdrawal command from the user, each communication terminal can also accept a command for selecting the management terminal from among the communication terminals that are currently connected to the chat communication.

At the start of the chat communication, ST of memory 103 of terminal A stores information indicating that terminal A is carrying out the chat communication, that is, information indicating that terminal A is being connected to the chat communication, for each communication terminal. POS of memory 103 has not yet stored the current location information for each communication terminal. Memory 103 has not yet stored the predefined packet group for any communication terminal. Since the states of memories 103 of terminal B to terminal E are similar to that of terminal A, description thereof will not be repeated here.

(Data Flow of Current Location Information)

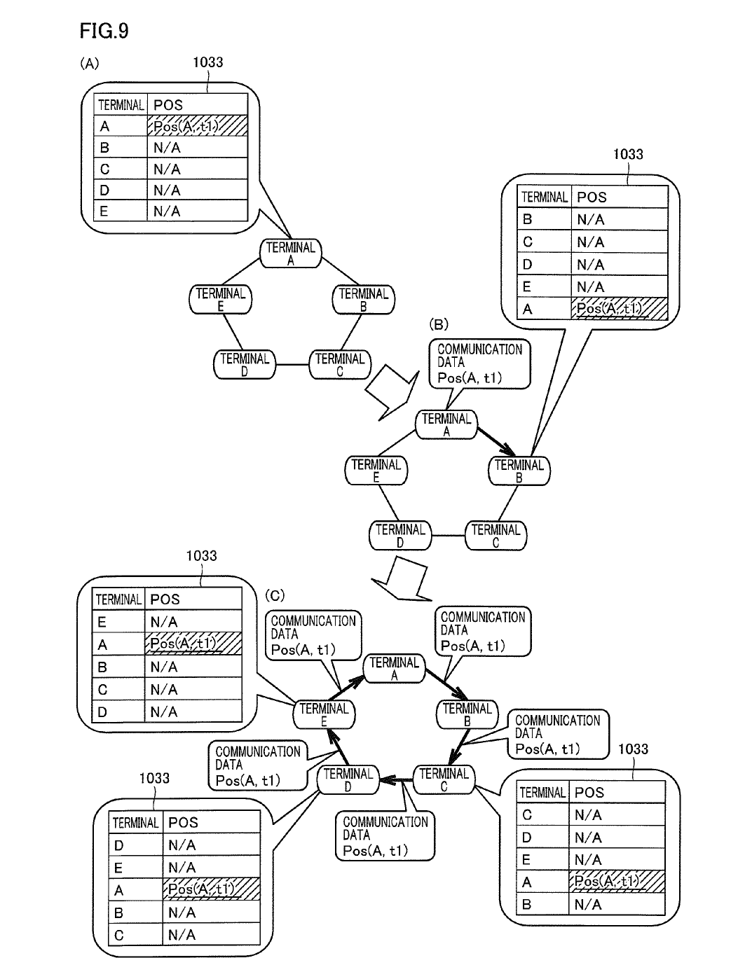

Next, a description will be given of one example of a configuration for conveying current location information obtained by each terminal to another communication terminal. FIG. 9 is an image diagram showing a data flow of current location information obtained by terminal A in network system 1 according to the present embodiment.

Referring to FIG. 9(A), GPS unit 102 of terminal A obtains current location information indicating a terminal A's own current location. GPS unit 102 stores the obtained current location information, corresponding to the terminal A's own list number, in POS of memory 103.

As shown in FIG. 9(B), terminal A transmits the obtained current location information (predefined packet) to terminal B through Internet network 500 using communication device 101. Terminal B receives the current location information from terminal A via its own communication device 101. Terminal B stores the current location information in POS of its own memory 103 in association with the list number of terminal A.

Referring to FIG. 9(C), terminal B transmits the current location information of terminal A to terminal C via its own communication device 101. Terminal C stores the current location information of terminal A received from terminal B in POS of its own memory 103 in association with the list number of terminal A. Terminal C transmits the current location information of terminal A to terminal D. Terminal D receives the current location information of terminal A from terminal C. Terminal D stores the current location information in POS of its own memory 103 in association with the list number of terminal A. Terminal D transmits the current location information of terminal A to terminal E. Terminal E receives the current location information of terminal A from terminal D, and stores the current location information of terminal A in POS of its own memory 103 in association with the list number of terminal A. Terminal E transmits the current location information of terminal A to terminal A. Terminal A receives its own current location information from terminal E, and abandons the current location information.

In this way, the current location information of terminal A obtained by terminal A is shared by terminal A to terminal E. For example, terminal B can cause display 107 to display the current location of terminal A on the map, based on the current location information of terminal A.

(Data Flow When Terminal B Withdraws)

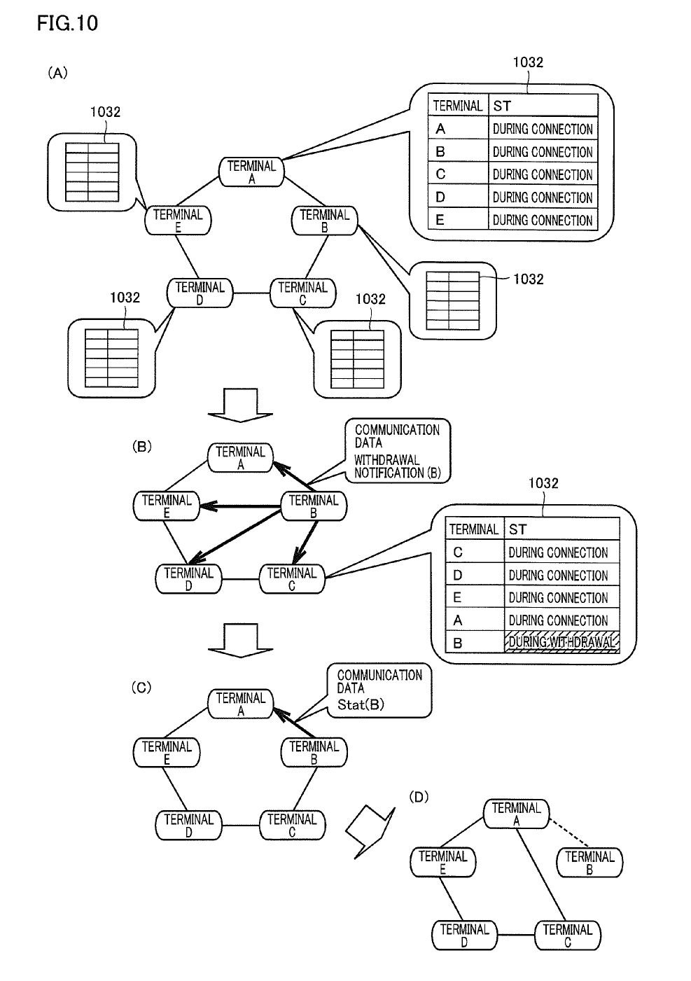

Next, a description will be given of a data flow when terminal B withdraws from the chat communication during the chat communication. FIG. 10 is an image diagram showing the data flow when terminal B withdraws from the chat communication during the chat communication in network system 1 according to the present embodiment.

Referring to FIG. 10(A), during the chat communication, ST of memory 103 of each communication terminal stores information indicating that each communication terminal is being connected to the chat communication, as status information ST of each communication terminal. In this state, a user of terminal B inputs a withdrawal command to terminal B.

Referring to FIG. 10(B), terminal B accepts the withdrawal command from the user, and transmits a withdrawal notification to terminal A, terminal C, terminal D, and terminal E via communication device 101. Terminal A, terminal C, terminal D, and terminal E change status information ST of their own memories 103 corresponding to terminal B during withdrawal. As described above, a terminal for managing each communication terminal is set as a terminal on the upstream side of the each communication terminal.

Referring to FIG. 10(C), terminal B transmits status information (Stat(B)) of terminal B indicating the state of terminal B at the time of withdrawal to terminal A, which is a communication terminal that should manage terminal B itself. Terminal A receives the status information from terminal B, and stores information for identifying terminal B in its own memory 103 in association with the status information of terminal B. Thereafter, terminal A starts to accumulate a predefined packet group for terminal B in memory 103.

Referring to FIG. 10(D), terminal A transmits a message that terminal A has received the status information to terminal B. Terminal B receives the message and withdraws from the chat communication. As a result, withdrawal of terminal B from the chat communication is completed.

(Data Flow During Withdrawal of Terminal B)

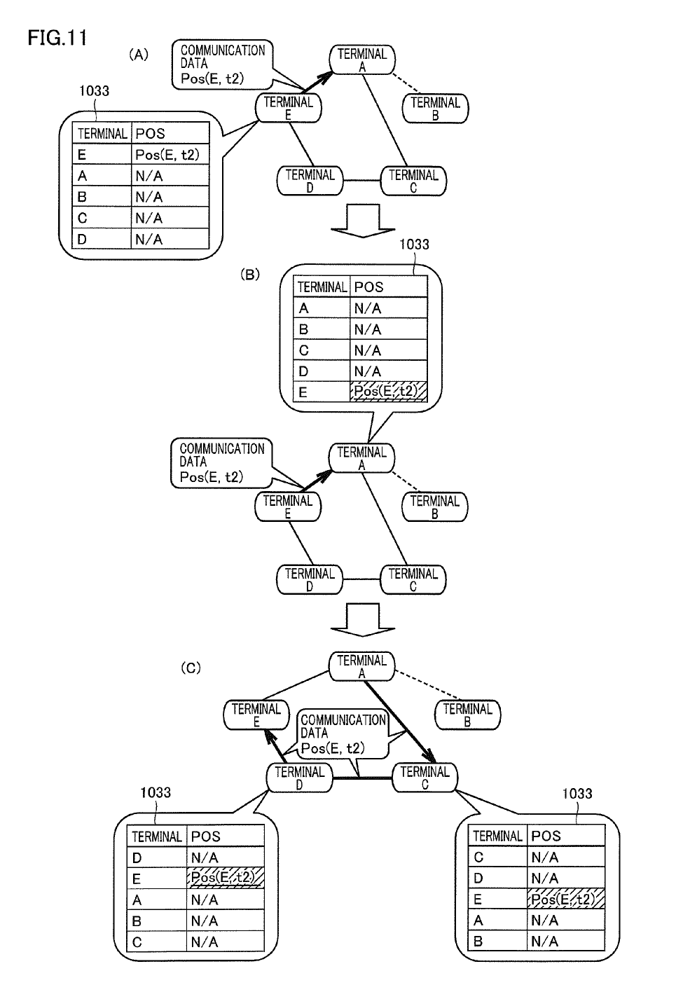

Next, a description will be given of a data flow during withdrawal of terminal B from the chat communication. FIG. 11 is an image diagram showing the data flow during withdrawal of terminal B from the chat communication in network system 1 according to the present embodiment. The case will be described hereinafter where terminal E obtains current location information using GPS unit 102.

Referring to FIG. 11(A), terminal E obtains its own current location information using its own GPS unit 102. Terminal E stores the current location information of terminal E in POS of memory 103 in association with terminal E. Terminal E transmits the current location information of terminal E to terminal A.

Referring to FIG. 11(B), terminal A receives the current location information of terminal E from terminal E, and stores the current location information of terminal E in POS of its own memory 103 in association with terminal E. In other words, terminal A updates POS of memory 103.

Then, terminal A stores the current location information of terminal E in memory 103 in association with terminal E. At this time, the information for identifying terminal B, the status information of terminal B and the current location information of terminal E are stored in memory 103 in association with one another.

Referring to FIG. 11(C), terminal A transmits the received current location information of terminal E to terminal C. Terminal C receives the current location information of terminal E from terminal A, and stores the current location information of terminal E in POS of its own memory 103 in association with terminal E. Then, terminal C transmits the current location information of terminal E to terminal D. Terminal D receives the current location information of terminal E from terminal C, and stores the current location information of terminal E in POS of its own memory 103 in association with terminal E. Terminal D transmits the current location information of terminal D to terminal E. Terminal E receives the current location information of terminal E from terminal D, and abandons the current location information of terminal E.

(Data Flow When Terminal B Returns)

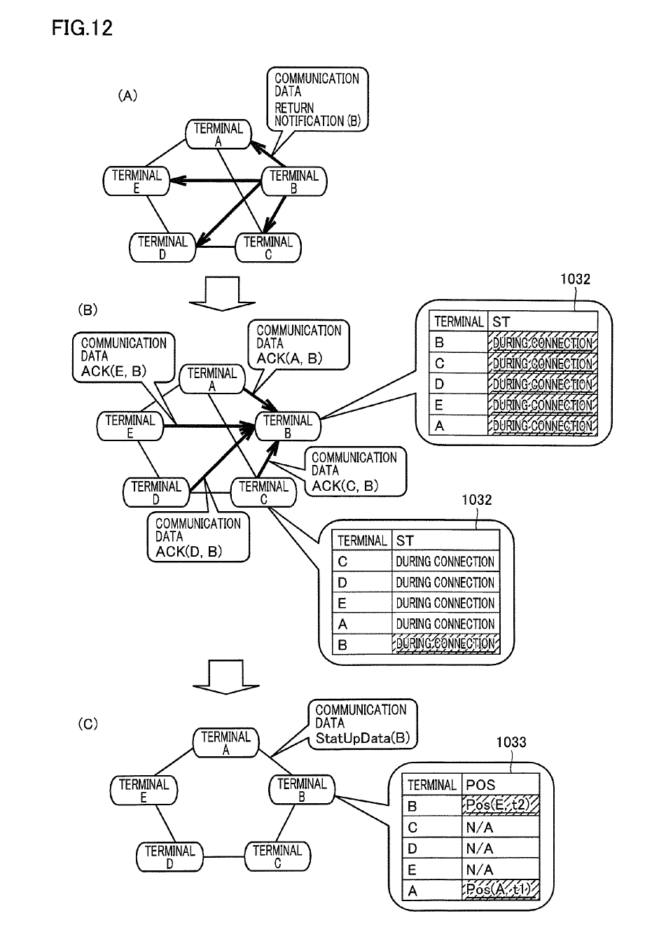

Next, a description will be given of a data flow when terminal B that has withdrawn from the chat communication returns to the chat communication. FIG. 12 is an image diagram showing the data flow when terminal B returns to the chat communication in network system 1 according to the present embodiment.

Referring to FIG. 12(A), when terminal B returns to the chat communication, terminal B accepts a return command from the user, and transmits a return notification to terminal A, terminal C, terminal D, and terminal E via communication device 101.

Referring to FIG. 12(B), terminal A, terminal C, terminal D, and terminal E receive the return notification from terminal B, and transmit an ACK (acknowledgement) message to terminal B. At this time, terminal A, terminal C, terminal D, and terminal E change status information ST of their own memories 103 corresponding to terminal B during connection.

Referring to FIG. 12(C), terminal B receives the ACK message from terminal A, terminal C, terminal D, and terminal E via communication device 101. Terminal B changes status information ST, corresponding to each communication terminal, of its own memory 103 during connection. In response to the return notification from terminal B, terminal A that should manage terminal B refers to memory 103 and transmits the predefined packet group for terminal B stored in memory 103 to terminal B. Terminal B receives the predefined packet group from terminal A, and stores the predefined packet group in memory 103. Terminal B can cause display 107 to display an image based on the predefined packet group. Since the subsequent data flow of the current location information, the message and the like is as shown in FIG. 9, description thereof will not be repeated here.

(Data Flow When Terminal A Withdraws During Withdrawal of Terminal B)

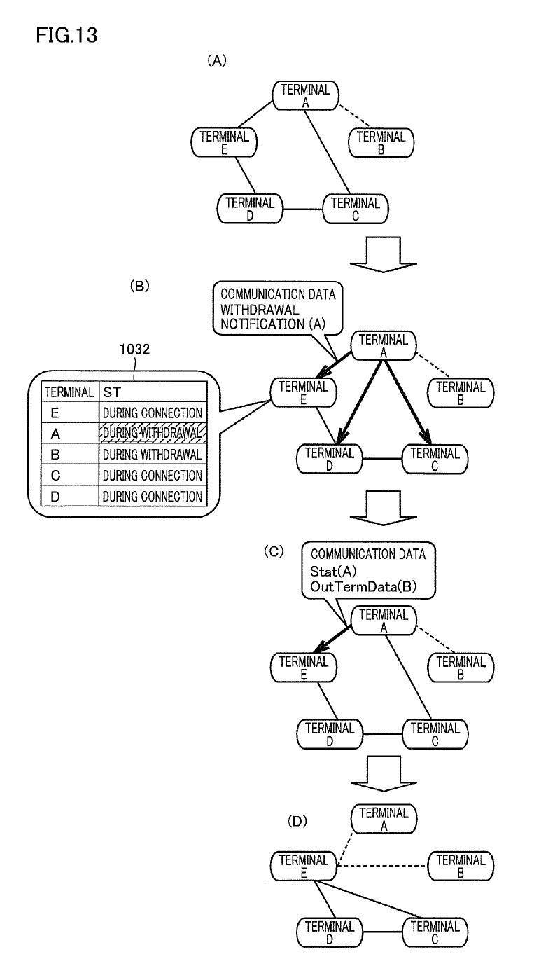

Next, a description will be given of a data flow when terminal A further withdraws from the chat communication during withdrawal of terminal B from the chat communication. FIG. 13 is an image diagram showing the data flow when terminal A further withdraws during withdrawal of terminal B.

Referring to FIG. 13(A), during withdrawal of terminal B from the chat communication, terminal A that should manage terminal B keeps the predefined packet group corresponding to terminal B in memory 103.

Referring to FIG. 13(B), the user of terminal A inputs the withdrawal command to terminal A. In response to the withdrawal command, terminal A transmits the withdrawal notification via communication device 101 to terminal C, terminal D and terminal E that are set in ST of memory 103 as being connected to the chat communication. Terminal C, terminal D and terminal E receive the withdrawal notification from terminal A, and change status information ST of their own memories 103 corresponding to terminal A during withdrawal. Here, a terminal that should manage terminal A is terminal E that is a terminal on the upstream side of terminal A.

Referring to FIG. 13(C), terminal A transmits status information indicating the state of terminal A at the time of withdrawal to terminal E. At this time, terminal A keeps the predefined packet group corresponding to terminal B in memory 103, and thus, terminal A transmits, to terminal E, the predefined packet group corresponding to terminal B that has been accumulated previously. Terminal E receives the withdrawal notification and the status information of terminal A from terminal A, and stores the information for identifying terminal A and the status information of terminal A in memory 103 in association with each other. In addition, terminal E receives the predefined packet group for terminal B from terminal A, and stores the information for identifying terminal B, the status information of terminal B and the predefined packet group for terminal B in its own memory 103 in association with one another. As a result, for terminal A and terminal B, terminal E starts to accumulate the current location information of each communication terminal transmitted and received by the chat communication.

Referring to FIG. 13(D), terminal A receives, from terminal E, a message that terminal E has received the withdrawal notification or a message that terminal E has received the status information of terminal A, and withdraws from the chat communication. As a result, withdrawal of terminal A from the chat communication is completed.

(Data Flow When Terminal A First Returns)

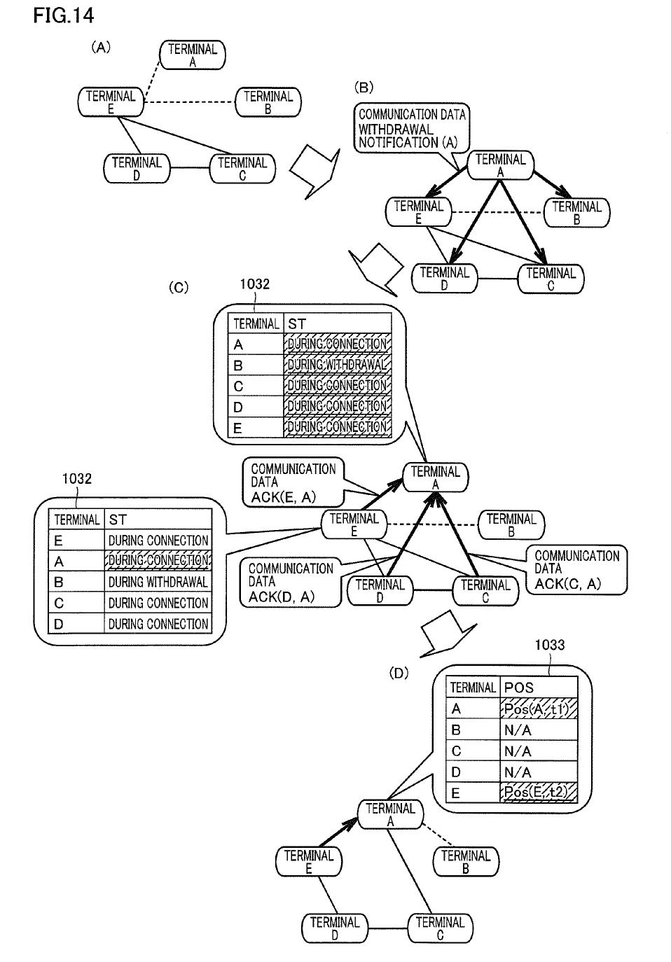

Next, a description will be given of a data flow when terminal A first returns to the chat communication during withdrawal of terminal A and terminal B from the chat communication. FIG. 14 is an image diagram showing the data flow when terminal A first returns to the chat communication.

Referring to FIG. 14(A), terminal A and terminal B are not participating in the chat communication. Terminal C, terminal D and terminal E are carrying out the chat communication.

Referring to FIG. 14(B), when the user of terminal A inputs the return command to terminal A, terminal A transmits the return notification to terminal B, terminal C, terminal D, and terminal E.

Referring to FIG. 14(C), in response to the return notification from terminal A, terminal C, terminal D and terminal E change status information ST of their own memories 103 corresponding to terminal A during connection. Terminal C, terminal D and terminal E receive the return information from terminal A and transmit the ACK message to terminal A. Terminal A receives the ACK message from terminal C, terminal D and terminal E, and changes status information ST of its own memory 103 corresponding to terminal A, terminal C, terminal D, and terminal E during connection.

Referring to FIG. 14(D), since terminal A returns to the chat communication, terminal E transmits the status information of terminal A and a predefined packet group for terminal A to terminal A. In addition, since terminal A is a terminal that should manage terminal B, terminal E transmits the status information of terminal B and the predefined packet group for terminal B to terminal A. Terminal A receives the status information of terminal A and the predefined packet group for terminal A from terminal E, and stores the status information of terminal A and the predefined packet group for terminal A in memory 103.

As a result, terminal A can refer to the status information of terminal A and the predefined packet group for terminal A, and cause display 107 to display an image such as the movement route of another communication terminal. At this time, the current location information of terminal E is transmitted from terminal E to terminal A, and terminal A stores the latest current location information of terminal E in POS of its own memory 103 in association with terminal E.

Then, terminal A stores the information for identifying terminal B, the status information of terminal B and the predefined packet group for terminal B in its own memory 103 in association with one another. As a result, return of terminal A to the chat communication is completed. Thereafter, the current location information is transmitted and received among terminal A, terminal C, terminal D, and terminal E. For terminal B, terminal A accumulates the current location information in memory 103 as the predefined packet group.

(Data Flow When Terminal B First Returns)

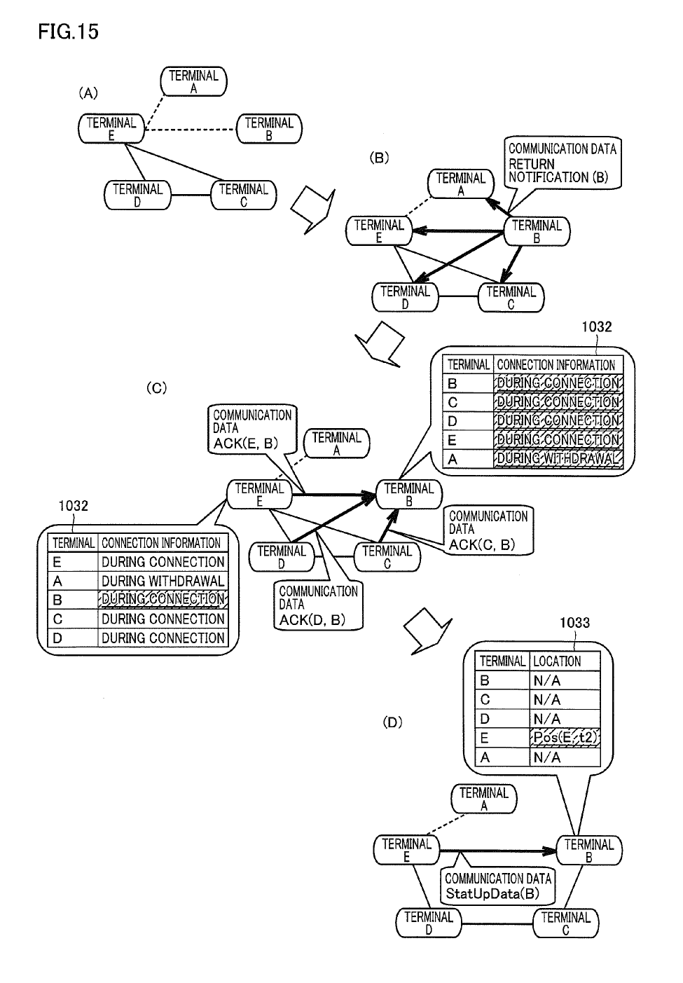

Next, a description will be given of a data flow when terminal B first returns to the chat communication during withdrawal of terminal A and terminal B from the chat communication. FIG. 15 is an image diagram showing the data flow when terminal B first returns to the chat communication.

Referring to FIG. 15(A), terminal A and terminal B are not participating in the chat communication. Terminal C, terminal D and terminal E are carrying out the chat communication.

Referring to FIG. 15(B), when the user of terminal B inputs the return command to terminal B, terminal B transmits the return notification to terminal A, terminal C, terminal D, and terminal E.

Referring to FIG. 15(C), in response to the return notification from terminal A, terminal C, terminal D and terminal E change status information ST of their own memories 103 corresponding to terminal B during connection. Terminal C, terminal D and terminal E receive the return notification from terminal B and transmit the ACK message to terminal B. Terminal B receives the ACK message from terminal C, terminal D and terminal E, and changes status information ST of its own memory 103 corresponding to terminal B, terminal C, terminal D, and terminal E during connection.

Referring to FIG. 15(D), since terminal B returns to the chat communication, terminal E transmits the status information of terminal B and the predefined packet group for terminal B to terminal B. Terminal B receives the status information of terminal B and the predefined packet group for terminal B from terminal E, and stores these in memory 103. As a result, terminal B can cause display 107 to display an image such as the movement route of another communication terminal based on the status information of terminal B and the predefined packet group for terminal B. At this time, the current location information of terminal E is transmitted from terminal E to terminal B, and terminal B stores the latest current location information of terminal E in POS of its own memory 103 in association with terminal E.

Since terminal B is not a terminal that should manage terminal A, that is, terminal E is a terminal that should manage terminal A, terminal E still keeps the status information of terminal A and the predefined packet group for terminal A in its own memory 103.

(Modification of Data Flow of Current Location Information)

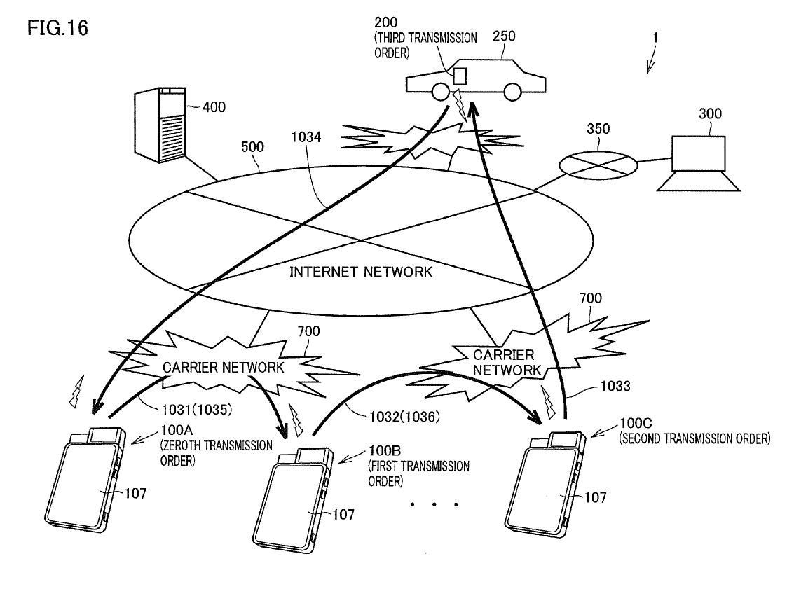

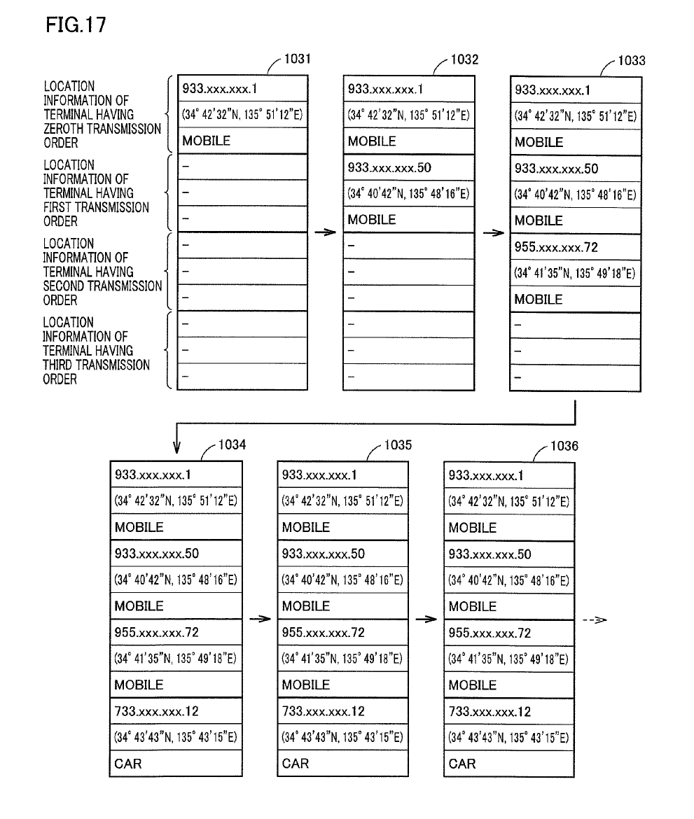

Next, a description will be given of a modification of the configuration for conveying current location information obtained by each terminal to another communication terminal. FIG. 16 is an image diagram showing a modification of the data flow of current location information obtained by terminal A in network system 1. FIG. 17 is an image diagram showing transmission and reception data of the current location information in network system 1 according to the present modification.

Referring to FIGS. 16 and 17, in the present modification, when the P2P communication starts, communication control unit 1061 of first mobile phone 100A having the zeroth transmission order transmits current location information (predefined packet) of first mobile phone 100A to second mobile phone 100B having the first transmission order via communication device 101.

Communication control unit 1061 of second mobile phone 100B receives the current location information of first mobile phone 100A via communication device 101, and stores the current location information of first mobile phone 100A in POS of memory 103 of second mobile phone 100B itself. Communication control unit 1061 of second mobile phone 100B transmits the current location information of first mobile phone 100A and second mobile phone 100B to third mobile phone 100C having the second transmission order via communication device 101.

Communication control unit 1061 of third mobile phone 100C receives the current location information of first mobile phone 100A and second mobile phone 100B via communication device 101, and stores the current location information of first mobile phone 100A and second mobile phone 100B in POS of memory 103 of third mobile phone 100C itself. Communication control unit 1061 of third mobile phone 100C transmits the current location information of first mobile phone 100A, second mobile phone 100B and third mobile phone 100C to satellite navigation system 200 having the third transmission order via communication device 101.

Communication control unit 1061 of satellite navigation system 200 receives the current location information of first mobile phone 100A, second mobile phone 100B and third mobile phone 100C via communication device 101, and stores the current location information of first mobile phone 100A, second mobile phone 100B and third mobile phone 100C in POS of memory 103 of satellite navigation system 200 itself. Communication control unit 1061 of satellite navigation system 200 transmits the current location information of first mobile phone 100A, second mobile phone 100B, third mobile phone 100C, and satellite navigation system 200 to first mobile phone 100A via communication device 101.

Communication control unit 1061 of first mobile phone 100A receives the current location information of first mobile phone 100A, second mobile phone 100B, third mobile phone 100C, and satellite navigation system 200 via communication device 101, and updates current location information POS of second mobile phone 100B, third mobile phone 100C and satellite navigation system 200 stored in memory 103 of first mobile phone 100A itself.

At this time, the latest current location information obtained by GPS unit 102 of first mobile phone 100A may have already been stored in variable POS of memory 103 of first mobile phone 100A corresponding to first mobile phone 100C. Alternatively, at this time, GPS unit 102 of first mobile phone 100A may obtain the latest current location information and update POS corresponding to first mobile phone 100A itself based on the latest current location information.

Communication control unit 1061 of first mobile phone 100A transmits current location information POS corresponding to first mobile phone 100A, second mobile phone 100B, third mobile phone 100C, and satellite navigation system 200 that is stored in memory 103, to second mobile phone 100B via communication device 101.

Communication control unit 1061 of second mobile phone 100A receives the current location information of first mobile phone 100A, second mobile phone 100B, third mobile phone 100C, and satellite navigation system 200 via communication device 101, and updates the current location information of first mobile phone 100A, third mobile phone 100C and satellite navigation system 200 stored in memory 103 of second mobile phone 100B itself.

At this time, the latest current location information obtained by GPS unit 102 of second mobile phone 100B may have already been stored in memory 103 of second mobile phone 100B. Alternatively, at this time, GPS unit 102 of second mobile phone 100B may obtain the latest current location information and update POS of memory 103 based on the latest current location information.

Communication control unit 1061 of second mobile phone 100B transmits the current location information of first mobile phone 100A, second mobile phone 100B, third mobile phone 100C, and satellite navigation system 200 that is stored in memory 103, to third mobile phone 100C via communication device 101.

In this way, each communication terminal configuring network system 1 according to the present modification transmits, like a bucket brigade, the current location information of all members to another communication terminal to which the transmission order subsequent to the transmission order allocated to the terminal itself is allocated, and thus, all members can share the current location information of all members.

<Data Transmission Processing>

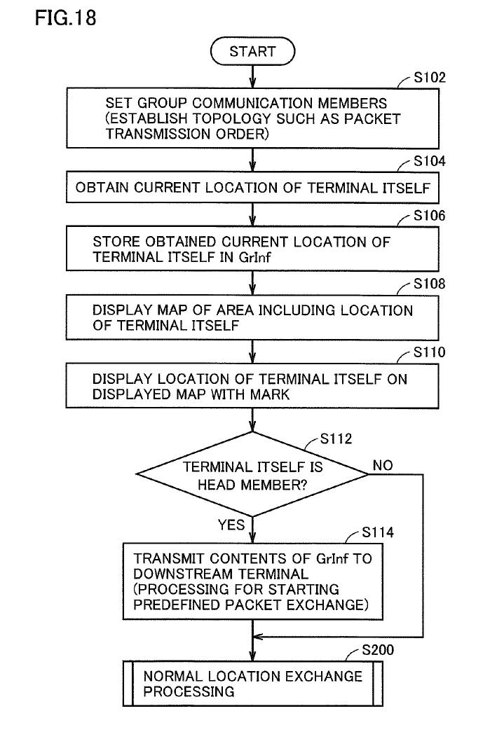

Next, a description will be given of a procedure of data transmission processing performed in the communication terminal according to the present embodiment. FIG. 18 is a flowchart showing the procedure of the data transmission processing performed in the communication terminal according to the present embodiment.

Referring to FIG. 18, CPU 106 makes settings about members that carry out group communication through Internet network 500 (step S 102). CPU 106 obtains current location information of the terminal itself using GPS unit 102 (step S104).

CPU 106 stores the obtained current location information of the terminal itself in GrInf[] of memory 103 (step S106). CPU 106 causes display 107 to display a map of an area including the current location of the terminal itself (step S108).

CPU 106 causes display 107 to display a mark indicating the current location of the terminal itself on the map, based on the current location information of the terminal itself (step S110). CPU 106 determines whether or not the terminal itself is a head member of the group communication (step S 112). If the terminal itself is the head member of the group communication (YES in step S 112), CPU 106 transmits data stored in GrInf[] of memory 103 to a downstream terminal via communication device 101 (step S114).

CPU 106 performs normal location exchange processing (step S200). It is to be noted that the normal location exchange processing (step S200) will be described later.

On the other hand, if the terminal itself is not the head member of the group communication (NO in step S112), CPU 106 performs the normal location exchange processing (step S200).

<Normal Location Exchange Processing>

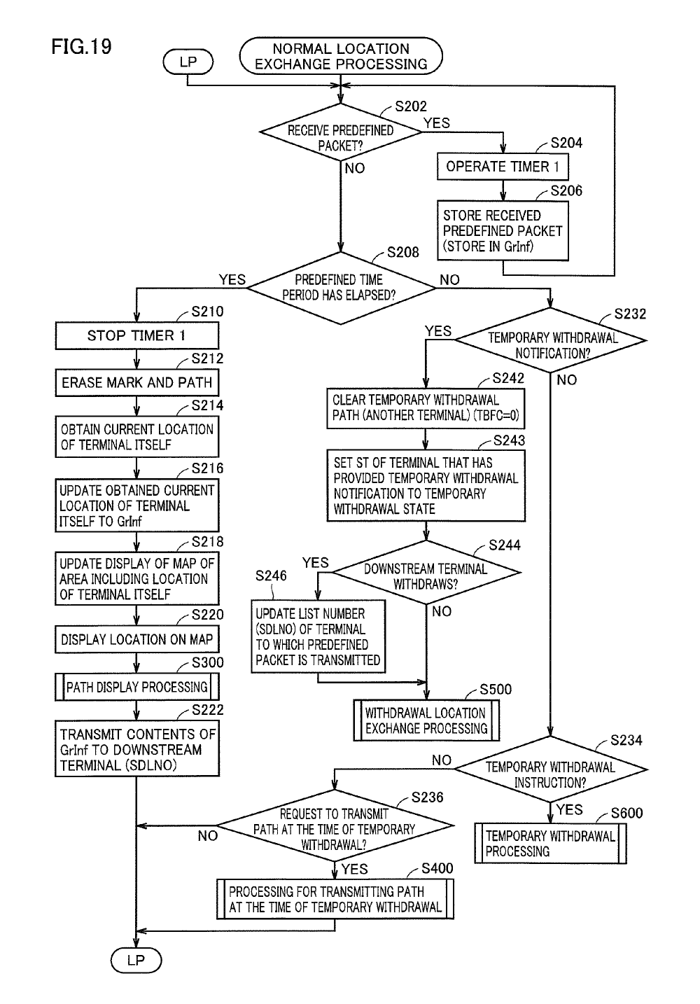

Next, a description will be given of a procedure of the normal location exchange processing performed in the communication terminal according to the present embodiment. FIG. 19 is a flowchart showing the procedure of the normal location exchange processing performed in the communication terminal according to the present embodiment.

Referring to FIG. 19, CPU 106 determines whether or not CPU 106 has received a predefined packet from another terminal in the group via communication device 101 (step S202). If CPU 106 has received the predefined packet from another terminal in the group (YES in step S202), CPU 106 operates a timer 1 (step S204). In other words, CPU 106 causes timer unit 105 to measure a time period from this point in time. CPU 106 stores the predefined packet received via communication device 101 in GrInf[] of memory 103 (step S206). CPU 106 repeats the processing from step S202.

If CPU 106 has not received the predefined packet from another terminal in the group (NO in step S202), CPU 106 refers to timer 1 and determines whether or not a predefined time period has elapsed (step S208). If the predefined time period has elapsed (YES in step S208), CPU 106 stops timer 1 (step S210). CPU 106 erases the mark indicating the location of the terminal and a path indicating a movement route of the terminal, using display 107 (step S212).

CPU 106 obtains the current location information of the terminal itself via GPS unit 102 (step S214). CPU 106 stores the obtained current location information of the terminal itself in GrInf[] of memory 103 (step S216). In other words, CPU 106 updates GrInf[] of memory 103 based on the new current location information of the terminal itself.

CPU 106 causes display 107 to display the map of the area including the current location of the terminal itself (step S218). CPU 106 causes display 107 to display the current location of the terminal itself on the map, based on the current location information of the terminal itself (step S220). CPU 106 performs path display processing (step S300). It is to be noted that the path display processing (step S300) will be described later.

CPU 106 transmits the data stored in GrInf[] of memory 103 to the downstream terminal using communication device 101 (step S222). CPU 106 repeats the processing from step S202.

On the other hand, if the predefined time period has not elapsed (NO in step S208), CPU 106 determines whether or not CPU 106 has received a temporary withdrawal notification from another terminal in the group via communication device 101 (step S232). If CPU 106 has not received the temporary withdrawal notification from another terminal in the group (NO in step S232), CPU 106 determines whether or not CPU 106 has accepted a temporary withdrawal instruction from the user of the terminal itself via input unit 104 (step S234). If CPU 106 has not accepted the temporary withdrawal instruction (NO in step S234), CPU 106 determines whether or not CPU 106 has accepted a request to transmit a path at the time of temporary withdrawal (step S236).

If CPU 106 has not accepted the request to transmit the path at the time of temporary withdrawal (NO in step S236), CPU 106 repeats the processing from step S202.

If CPU 106 has accepted the request to transmit the path at the time of temporary withdrawal (YES in step S236), CPU 106 performs path transmission processing (step S400). It is to be noted that the path transmission processing (step S400) will be described later.

If CPU 106 has accepted the temporary withdrawal instruction (YES in step S234), CPU 106 performs temporary withdrawal processing (step S600). It is to be noted that the temporary withdrawal processing (step S600) will be described later.

If CPU 106 has received the temporary withdrawal notification from another terminal in the group via communication device 101 (YES in step S232), CPU 106 clears a temporary withdrawal path about another terminal (step S242). In other words, CPU 106 initializes TBFC of memory 103. CPU 106 sets status information ST of the terminal that has provided the temporary withdrawal notification to the temporary withdrawal state (step S243). CPU 106 determines whether or not a terminal, of the group terminals, located on the downstream side of the terminal itself has withdrawn (step S244).

If a terminal, of the group terminals, located on the downstream side of the terminal itself has withdrawn (YES in step S244), CPU 106 updates the list number of a terminal to which the predefined packet should be transmitted (step S246). In other words, CPU 106 updates SDLNO of memory 103. CPU 106 performs withdrawal location exchange processing (step S500). It is to be noted that the withdrawal location exchange processing (step S500) will be described later.

If a terminal, of the group terminals, that is not located on the downstream side of the terminal itself has withdrawn (NO in step S244), CPU 106 performs the withdrawal location exchange processing (step S500).

<Path Display Processing>

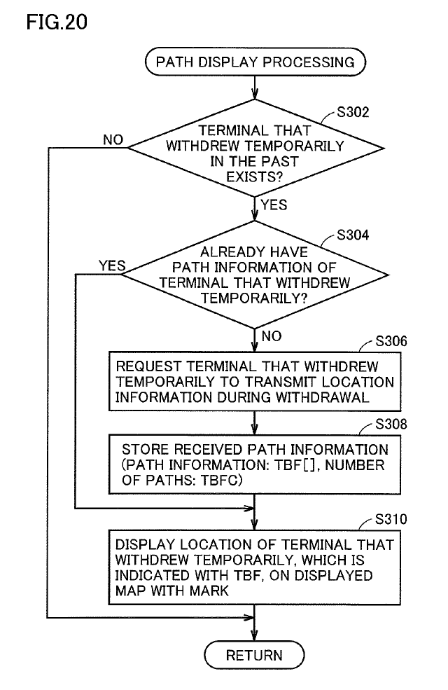

Next, a description will be given of the path display processing performed in the communication terminal according to the present embodiment. FIG. 20 is a flowchart showing a procedure of the path display processing performed in the communication terminal according to the present embodiment.

Referring to FIG. 20, CPU 106 determines whether or not a terminal that withdrew temporarily in the past exists (step S302). If a terminal that withdrew temporarily in the past does not exist (NO in step S302), CPU 106 ends the path display processing.

If a terminal that withdrew temporarily in the past exists (YES in step S302), CPU 106 determines whether or not memory 103 has already had path information group of the terminal that withdrew temporarily (step S304). If memory 103 has had the path information group of the terminal that withdrew temporarily (YES in step S304), CPU 106 performs the processing from step S310 that will be described later.

If memory 103 does not have the path information group of the terminal that withdrew temporarily (NO in step S304), CPU 106 requests the terminal that withdrew temporarily to transmit location information during withdrawal, using communication device 101 (step S306). CPU 106 receives the path information group via communication device 101 from the terminal that withdrew temporarily, and stores the received path information group in memory 103 (step S308). In other words, CPU 106 stores the received path information group in TBF[] of memory 103 and stores the number of data of the path information in TBFC.

CPU 106 refers to TBF[] of memory 103 and causes display 107 to display a location of the terminal that withdrew temporarily on the displayed map with a mark (step S310).

<Path Transmission Processing>

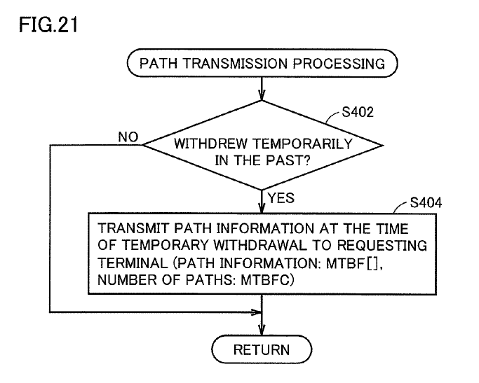

Next, a description will be given of the path transmission processing performed in the communication terminal according to the present embodiment. FIG. 21 is a flowchart showing a procedure of the path transmission processing performed in the communication terminal according to the present embodiment.

Referring to FIG. 21, CPU 106 determines whether or not the terminal itself withdrew temporarily in the past (step S402). If the terminal itself withdrew temporarily in the past (YES in step S402), CPU 106 refers to memory 103 and transmits path information group during temporary withdrawal to a terminal requesting this information (step S404). In other words, CPU 106 transmits a data group stored in MTBF[] of memory 103 to the terminal requesting this information, using communication device 101.

On the other hand, if the terminal itself did not withdraw temporarily in the past (NO in step S402), CPU 106 ends the path transmission processing (step S400).

<Location Exchange Processing>

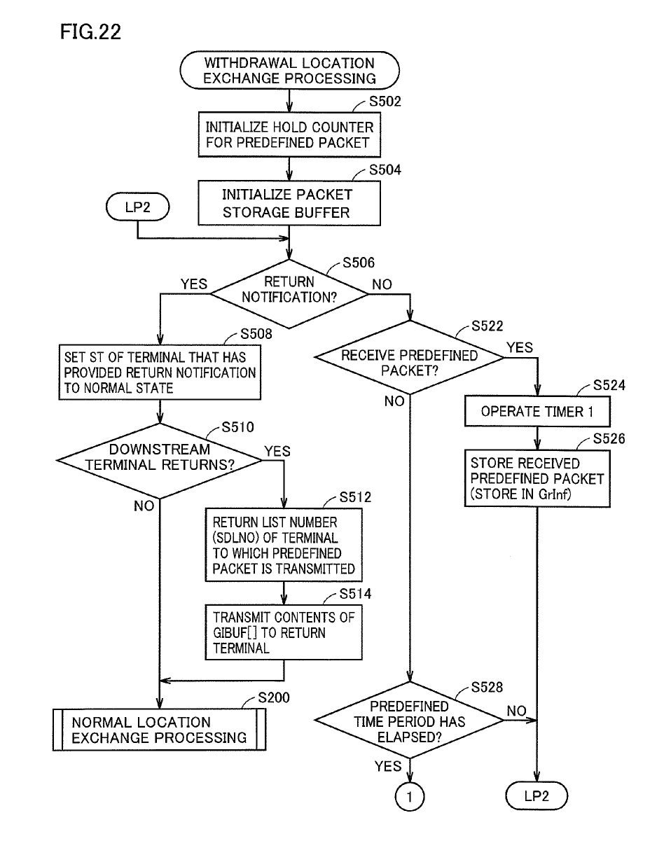

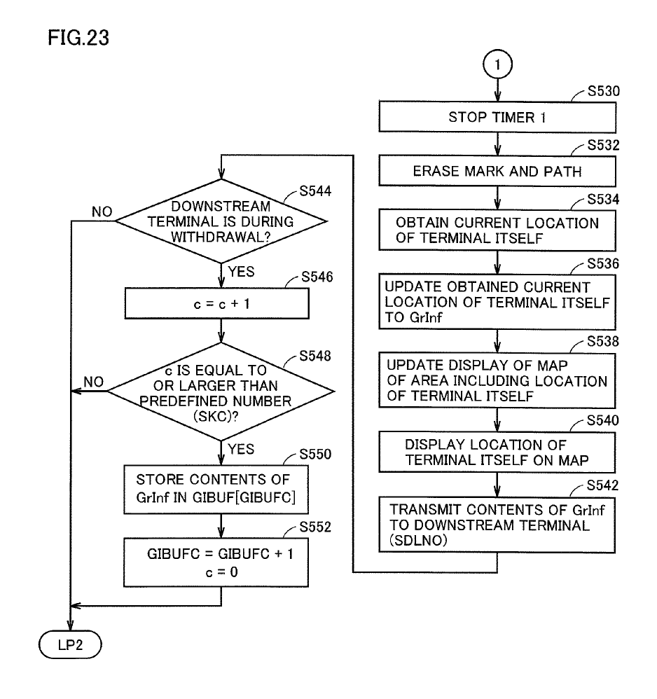

Next, a description will be given of the location exchange processing performed in the communication terminal according to the present embodiment. FIG. 22 is a first flowchart showing a procedure of the location exchange processing performed in the communication terminal according to the present embodiment. FIG. 23 is a second flowchart showing the procedure of the location exchange processing performed in the communication terminal according to the present embodiment.

Referring to FIGS. 22 and 23, CPU 106 initializes a hold counter (a variable c of memory 103) for the predefined packet (step S502). CPU 106 initializes a predefined packet storage buffer of memory 103 (step S504).

CPU 106 determines whether or not CPU 106 has received a return notification from another terminal in the group communication using communication device 101 (step S506). If CPU 106 has received the return notification from another terminal in the group communication (YES in step S506), CPU 106 sets status information ST of the terminal that has provided the return notification to the normal state (step S508).

CPU 106 determines whether or not a terminal located on the downstream side of the terminal itself has returned (step S510). If a terminal located on the downstream side of the terminal itself has returned (YES in step S510), CPU 106 returns the list of the terminal to which the predefined packet is transmitted to the original state (step S512). In other words, CPU 106 returns the data stored in SDLNO of memory 103 to the state at the start of the group communication.

CPU 106 refers to memory 103 and transmits data stored in GIBUF[] to the terminal that has returned, using communication device 101 (step S514). CPU 106 performs the normal location exchange processing (step S200).

If a terminal that is not located on the downstream side of the terminal itself has returned (NO in step S510), CPU 106 performs the normal location exchange processing (step S200).

If CPU 106 has not received the return notification from another terminal in the group communication using communication device 101 (NO in step S506), CPU 106 determines whether or not CPU 106 has received the predefined packet from another terminal in the group communication using communication device 101 (step S522). If CPU 106 has received the predefined packet (YES in step S522), CPU 106 operates timer 1 (step S524).

CPU 106 stores the predefined packet received using communication device 101 in memory 103 (step S526). In other words, CPU 106 stores the predefined packet in GrInf[] of memory 103. CPU 106 repeats the processing from step S506.

If CPU 106 has not received the predefined packet (NO in step S522), CPU 106 determines whether or not a predefined time period has elapsed (step S528). If the predefined time period has not elapsed (NO in step S528), CPU 106 repeats the processing from step S506.

If the predefined time period has elapsed (YES in step S528), CPU 106 stops timer 1 (step S530). CPU 106 erases the mark indicating the location of the terminal and the path indicating the movement route of the terminal, using display 107 (step S532). CPU 106 obtains the current location information of the terminal itself using GPS unit 102 (step S534).

CPU 106 stores the obtained current location information of the terminal itself in GrInf[] of memory 103 (step S536). In other words, CPU 106 updates GrInf[] of memory 103 based on the obtained current location information of the terminal itself. CPU 106 causes display 107 to display the map of the area including the current location of the terminal itself (step S538). CPU 106 causes display 107 to display the current location of the terminal itself on the map (step S540).

CPU 106 transmits the data stored in GrInf[] of memory 103 to a downstream terminal using communication device 101 (step S542). CPU 106 determines whether or not a terminal, of the group terminals, located on the downstream side of the terminal itself is during withdrawal (step S544).

If a terminal, of the group terminals, located on the downstream side of the terminal itself is not during withdrawal (NO in step S544), CPU 106 repeats the processing from step S506. If a terminal, of the group terminals, located on the downstream side of the terminal itself is during withdrawal (YES in step S544), CPU 106 increments the value of variable c of memory 103 (step S546).

CPU 106 determines whether or not the value of variable c of memory 103 is equal to or larger than a predefined number (step S548). If the value of variable c of memory 103 is not equal to or larger than the predefined number (NO in step S548), CPU 106 repeats the processing from step S506.

If the value of variable c of memory 103 is equal to or larger than the predefined number (YES in step S548), CPU 106 stores the data stored in GrInf[] of memory 103 in GIBUF[] of memory 103 (step S550). CPU 106 increments the value of GIBUFC and initializes variable c (step S552). CPU 106 repeats the processing from step S506.

<Temporary Withdrawal Processing>

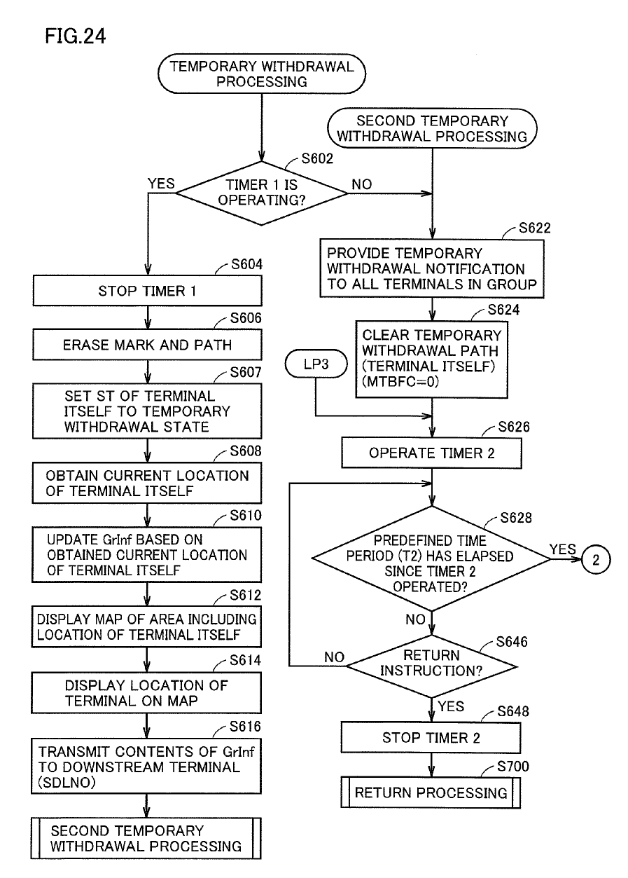

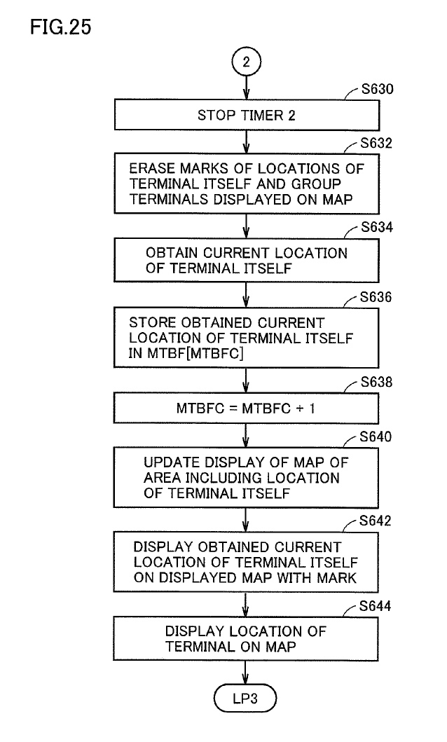

Next, a description will be given of the temporary withdrawal processing performed in the communication terminal according to the present embodiment. FIG. 24 is a first flowchart showing a procedure of the temporary withdrawal processing performed in the communication terminal according to the present embodiment. FIG. 25 is a second flowchart showing the procedure of the temporary withdrawal processing performed in the communication terminal according to the present embodiment.

Referring to FIG. 24, CPU 106 determines whether or not timer 1 is operating (step S602). If timer 1 is operating (YES in step S602), CPU 106 stops timer 1 (step S604). CPU 106 erases the mark indicating the current location of the terminal and the path indicating the movement route of the terminal, using display 107 (step S606).

CPU 106 sets status information ST of the terminal itself to the temporary withdrawal state (step S607). CPU 106 obtains the current location information of the terminal itself using GPS unit 102 (step S608). CPU 106 updates GrInf[] of memory 103 based on the obtained current location information of the terminal itself (step S610).

CPU 106 causes display 107 to display the map of the area including the current location of the terminal itself (step S612). CPU 106 causes display 107 to display the current location of the terminal on the map (step S614).

CPU 106 transmits the data stored in GrInf[] of memory 103 to a downstream terminal using communication device 101 (step S616). CPU 106 performs second temporary withdrawal processing. It is to be noted that the second temporary withdrawal processing refers to the processing from step S622 in the flowchart shown in FIG. 24.

On the other hand, if timer 1 is not operating (NO in step S602), or if the second temporary withdrawal processing starts, CPU 106 transmits the temporary withdrawal notification to all terminals that belong to the group communication, using communication device 101 (step S622). CPU 106 clears temporary withdrawal path information group about the terminal itself stored in memory 103 (step S624). In other words, CPU 106 substitutes zero into the value of MTBFC of memory 103.

CPU 106 operates a timer 2 (step S626). CPU 106 determines whether or not a predefined time period (T2) has elapsed since timer 2 started to operate (step S628).

If the predefined time period (T2) has not elapsed since timer 2 started to operate (NO in step S628), CPU 106 determines whether or not CPU 106 has accepted a return instruction from the user via input unit 104 (step S646). If CPU 106 has not accepted the return instruction via input unit 104 (NO in step S646), CPU 106 repeats the processing from step S628.

If CPU 106 has accepted the return instruction via input unit 104 (YES in step S646), CPU 106 stops timer 2 (step S648). CPU 106 performs return processing (step S700).

If the predefined time period (T2) has elapsed since timer 2 started to operate (YES in step S628), CPU 106 stops timer 2 (step S630). Using display 107, CPU 106 erases the marks indicating the current locations of the terminal itself and the group terminals displayed on the map (step S632).

CPU 106 obtains the current location information of the terminal itself using GPS unit 102 (step S634). CPU 106 stores the obtained current location information of the terminal itself in MTBF[MTBFC] of memory 103 (step S636). CPU 106 increments MTBFC (step S638).

CPU 106 causes display 107 to display the map of the area including the current location of the terminal itself (step S640). CPU 106 causes display 107 to display the mark indicating the current location of the terminal itself on the map (step S642). CPU 106 displays the current location of the terminal on the map (step S644). CPU 106 repeats the processing from step S626.

<Return Processing>

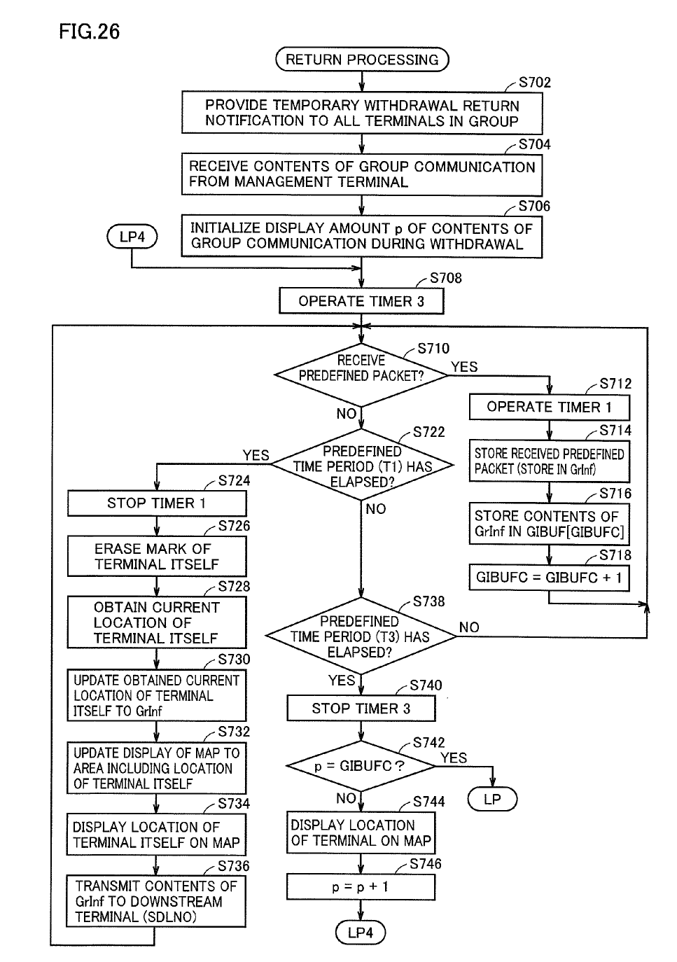

Next, a description will be given of the return processing performed in the communication terminal according to the present embodiment. FIG. 26 is a flowchart showing a procedure of the return processing performed in the communication terminal according to the present embodiment.

Referring to FIG. 26, CPU 106 provides a temporary withdrawal return notification to all terminals that belong to the group communication, using communication device 101 (step S702). CPU 106 receives data (predefined packet group) exchanged in the group communication, from the management terminal using communication device 101 (step S704).

CPU 106 initializes a display amount p of data (predefined packet group) exchanged in the group communication during withdrawal of the terminal itself, based on the data (predefined packet group) from the management terminal (step S706). CPU 106 operates a timer 3 (step S708).

CPU 106 determines whether or not CPU 106 has received the predefined packet from another terminal in the group communication via communication device 101 (step S710). If CPU 106 has received the predefined packet from another terminal (YES in step S710), CPU 106 operates timer 1 (step S712). CPU 106 stores the predefined packet received using communication device 101 in GrInf[] of memory 103 (step S714). CPU 106 stores the data stored in GrInf[] of memory 103 in GIBUF[GIBUFC] of memory 103 (step S716). CPU 106 increments variable GIBUFC of memory 103 (step S718). CPU 106 repeats the processing from step S710.

On the other hand, if CPU 106 has not received the predefined packet from another terminal (NO in step S710), CPU 106 determines whether or not a predefined time period (T1) has elapsed (step S722). If the predefined time period (T1) has elapsed (YES in step S722), CPU 106 stops timer 1 (step S724). CPU 106 erases the mark indicating the current location of the terminal itself, using display 107 (step S726).

CPU 106 obtains the current location information of the terminal itself using GPS unit 102 (step S728). CPU 106 stores the obtained current location information of the terminal itself in GrInf[] of memory 103 (step S730).

CPU 106 causes display 107 to display the map of the area including the current location of the terminal itself (step S723). CPU 106 causes display 107 to display the current location of the terminal itself on the map (step S734). CPU 106 transmits the data stored in GrInf[] of memory 103 to a downstream terminal using communication device 101 (step S736). CPU 106 repeats the processing from step S710.

If the predefined time period (T1) has not elapsed (NO in step S722), CPU 106 determines whether or not a predefined time period (T3) has elapsed (step S738). If the predefined time period (T3) has not elapsed (NO in step S738), CPU 106 repeats the processing from step S710.

If the predefined time period (T3) has elapsed (YES in step S738), CPU 106 stops timer 3 (step S740). CPU 106 determines whether or not variable p of the memory matches the value of variable GIBUFC (step S742). If variable p of memory 103 matches the value of variable GIBUFC (YES in step S742), CPU 106 repeats the processing from step S202.

If variable p of memory 103 does not match the value of variable GIBUFC (NO in step S742), CPU 106 causes display 107 to display the current location of the terminal on the map (step S744). CPU 106 increments the value of variable p of memory 103 (step S746). CPU 106 repeats the processing from step S710.

<Other Embodiments>

It is needless to say that the present invention is also applicable to a case where a program is provided to a system or a device to achieve the present invention. A storage medium storing a program represented by software for achieving the present invention may be provided to a system or a device and a computer (or CPU or MPU) of the system or the device may read and execute a program code stored in the storage medium, which can also provide the effects of the present invention.

In this case, the program code per se read from the storage medium implements the functions of the above-described embodiments, and the storage medium having the program code stored therein constitutes the present invention.

The storage medium for providing the program code can, for example, be a hard disk, an optical disk, a magneto-optical disk, a CD-ROM, a CD-R, a magnetic tape, a non-volatile memory card (an IC memory card), an ROM (mask ROM, flash EEPROM or the like), or the like.

Furthermore, it is needless to say that the functions of the above-described embodiments may also be implemented, not only by execution of the program code read by the computer, but also by actual processing partially or entirely executed by an OS (Operating System) and the like operating on the computer based on instructions of the program code.

Furthermore, it is also needless to say that the program code read from the storage medium may be written to a memory of a function expansion board inserted to the computer or a function expansion unit connected to the computer, and thereafter, a CPU or the like of the function expansion board or function expansion unit may perform a part or the whole of the actual processing based on instructions of the program code, so that the processing implements the functions of the above-described embodiments.

It should be understood that the embodiments disclosed herein are illustrative and non-restrictive in any respect. The scope of the present invention is defined by the terms of the claims, rather than the description above, and is intended to include any modifications within the scope and meaning equivalent to the terms of the claims.

### REFERENCE SIGNS LIST

1 network system; 100 communication terminal; 100A, 100B, 100E mobile phone; 101, 101A, 101B communication device; 102, 102A, 102B GPS unit; 103, 103A, 103B memory; 104 input unit; 105 timer unit; 106, 106A, 106B CPU; 107, 107A, 107B display; 110 backlight; 119 pen tablet; 200 satellite navigation system; 250 vehicle; 300 personal computer; 400 matching server; 500 Internet network; 700 carrier network; 1061A, 1061B communication control unit; 1062A, 1062B storage control unit; 1063A, 1063B display control unit; A, B, C, D, E communication terminal

1. A network system comprising at least a first terminal and a second terminal,
said first terminal including:
a first communication unit;
a memory;
a first obtaining unit for obtaining first data; and
a first control unit for detecting, using said first communication unit, whether said first terminal is in a first state in which said first terminal can exchange said first data with said second terminal or in a second state in which said first terminal cannot exchange said first data with said second terminal, thereby storing a part of said first data obtained during said second state in said memory as second data, and for transmitting said second data to said second terminal when a transition from said second state to said first state occurs,
said second terminal including:
a display;
a second communication unit;
a second control unit for sequentially receiving said first data from said first terminal using said second communication unit during said first state, and receiving said second data from said first terminal when the transition from said second state to said first state occurs; and
a display control unit for causing said display to sequentially display said first data and said second data.

2. The network system according to claim 1, wherein
said second terminal further includes a second obtaining unit for obtaining location information of said second terminal,
said first obtaining unit obtains location information of said first terminal as said first data, and
said display control unit causes said display to display locations of said first terminal and said second terminal based on the location information of said first terminal and said second terminal.

3. A communication terminal connectable to another terminal through a network, comprising:
a communication unit;
a memory;
a first obtaining unit for obtaining first data; and
a control unit for detecting, using said communication unit, whether said communication terminal is in a first state in which said communication terminal can exchange said first data with said another terminal or in a second state in which said communication terminal cannot exchange said first data with said another terminal, thereby storing a part of said first data obtained during said second state in said memory as second data, and for transmitting said second data to said another terminal when a transition from said second state to said first state occurs.

4. A communication terminal connectable to another terminal through a network, comprising:
a display;
a communication unit;
a communication control unit for sequentially receiving said first data from said another terminal using said communication unit during a first state in which said another terminal can exchange first data with said communication terminal, and receiving second data from said another terminal when a transition from a second state in which said another terminal cannot exchange said first data with said communication terminal to said first state occurs; and
a display control unit for causing said display to display said first data and said second data.

5. A communication method in a network system comprising at least a first terminal and a second terminal, comprising the steps of:
obtaining, by said first terminal, first data;
detecting, by said first terminal, whether said first terminal is in a first state in which said first terminal can exchange said first data with said second terminal or in a second state in which said first terminal cannot exchange said first data with said second terminal, thereby storing a part of said first data obtained during said second state in a memory as second data;
sequentially transmitting, by said first terminal, said first data to said second terminal during said first state;
sequentially receiving, by said second terminal, said first data from said first terminal during said first state;
transmitting, by said first terminal, said second data to said second terminal when a transition from said second state to said first state occurs;
receiving, by said second terminal, said second data from said first terminal when the transition from said second state to said first state occurs; and
causing, by said second terminal, a display to sequentially display said first data and said second data.

6. A communication method for a communication terminal connectable to another terminal through a network, the communication terminal including a communication unit, a processor and a memory, the communication method comprising the steps of:
obtaining, by said processor, first data;
detecting, by said processor, whether said communication terminal is in a first state in which said communication terminal can exchange said first data with said another terminal or in a second state in which said communication terminal cannot exchange said first data with said another terminal, using said communication unit, thereby storing a part of said first data obtained during said second state in said memory as second data; and
transmitting, by said processor, said second data to said another terminal using said communication unit when a transition from said second state to said first state occurs.

7. A communication method for a communication terminal connectable to another terminal through a network, the communication terminal including a communication unit, a processor and a display, the communication method comprising the steps of:
sequentially receiving, by said processor, first data from said another terminal using said communication unit during a first state in which said another terminal can exchange said first data with said communication terminal;
receiving, by said processor, second data from said another terminal using said communication unit when a transition from a second state in which said another terminal cannot exchange said first data with said communication terminal to said first state occurs; and
causing, by said processor, said display to sequentially display said first data and said second data.

8. A communication program for allowing communication of a communication terminal connectable to another terminal through a network, the communication terminal including a communication unit, a processor and a memory,
said communication program causing said processor to perform the steps of:
obtaining first data;
detecting, using said communication unit, whether said communication terminal is in a first state in which said communication terminal can exchange said first data with said another terminal or in a second state in which said communication terminal cannot exchange said first data with said another terminal, thereby storing a part of said first data obtained during said second state in said memory as second data; and
transmitting said second data to said another terminal using said communication unit when a transition from said second state to said first state occurs.

9. A communication program for allowing communication of a communication terminal connectable to another terminal through a network, the communication terminal including a communication unit, a processor and a display,
said communication program causing said processor to perform the steps of:
sequentially receiving said first data from said another terminal using said communication unit during a first state in which said another terminal can exchange first data with said communication terminal;
receiving second data from said another terminal using said communication unit when a transition from a second state in which said another terminal cannot exchange said first data with said communication terminal to said first state occurs; and
causing said display to sequentially display said first data and said second data.
